(19) United States
(12) Patent Application Publication
(10) Pub. No.: US 2025/0061044 A1
(43) Pub. Date: Feb. 20, 2025

(54) GAME DEVELOPMENT SUPPORT SYSTEM, GAME DEVELOPMENT SUPPORT METHOD, INFORMATION PROCESSING APPARATUS AND STORAGE MEDIUM

(71) Applicant: NINTENDO CO., LTD., Kyoto (JP)

(72) Inventors: Yasutoshi MAEGAWA, Kyoto (JP); Ayaka IDE, Kyoto (JP)

(21) Appl. No.: 18/401,987

(22) Filed: Jan. 2, 2024

(30) Foreign Application Priority Data
Aug. 16, 2023 (JP) 2023-132435

(51) Int. Cl. G06F 11/36; A63F 13/60; G06V 20/40

(52) U.S. Cl. CPC G06F 11/3612; A63F 13/60; G06V 20/46; G06V 2201/02

(57) ABSTRACT

A non-limiting example game development support system includes a game apparatus capable of executing an under-development game program and an information processing apparatus. The under-development game program causes a computer of the game apparatus to execute outputting a log during execution of game processing, and generating, within at least a predetermined period, a game image including an identification image by which a timing that the game image is output is identifiable. The information processing apparatus acquires the log and the video data that the game image is captured from the game apparatus, performs image analysis to the video data so as to specify a frame in which the identification image is included in the video, and to specify a timing that the game image in which the identification image is included is output, and generates, based on specified timing and timing information included in the log, a viewing image that includes at least the log and the video that are displayed synchronously.

### CROSS REFERENCE OF RELATED APPLICATION

This application claims a priority to Japanese Patent Application No. 2023-132435 filed on Aug. 16, 2023, and the entire contents of which are incorporated herein by reference.

### FIELD

This application discloses a game development support system, a game development support method, an information processing apparatus and a storage medium, which viewing a video that captures a game image displayed during execution of an under-development game program and logs generated and output during the execution of the under-development game program.

### BACKGROUND AND SUMMARY

In a conventional game development system, an under-development game program is executed in a game apparatus, and a log that is used in game processing is generated, and the log is transmitted to an information processing apparatus. The information processing apparatus displays the log acquired from the game apparatus, and a game developer views the log that is generated during the game processing.

Although the capture of a video of a game screen during a development of a game program is also often performed, since a timing that the game screen is displayed is uncertain in the video, it takes time and effort to view the log and the video synchronously using the information processing device included in the game development system as described above. This application will be describe an embodiment(s) providing a novel game development support system, game development support method, information processing apparatus and storage medium.

Moreover, this application will be describe the embodiment(s) providing a game development support system, game development support method, information processing apparatus and storage medium, capable of reducing time and effort in checking an operation of an under-development game program.

A first embodiment is a game development support system comprising at least a game apparatus capable of executing an under-development game program and an information processing apparatus. The under-development game program causes a computer of the game apparatus to execute: outputting a log during execution of game processing, the log including timing information; and generating, within at least a predetermined period during execution of the game processing, a game image so that an identification image by which a timing that the game image is output is identifiable is included therein. The information processing apparatus is caused to execute: acquiring the log from the game apparatus; acquiring video data that is generated by capturing the game image; performing image analysis to the video data so as to specify a frame in which the identification image is included in the video, and to specify a timing that the game image in which the identification image is included is output; and generating, based on specified timing and the timing information included in the log, a viewing image that includes at least the log and the video that are displayed synchronously.

According to the first embodiment, since it is possible to specify when the video is captured, and the video can be viewed while being synchronized with the log, and therefore, it is possible to reduce the time and effort required to confirm the operation of the under-development game program.

A second embodiment is the game development support system according to the first embodiment, wherein the identification image includes an image of information indicating a timing that the game image is being output, the image being located at a predetermined position in the game image.

According to the second embodiment, since the identification image is arranged in the predetermined position in the game image, it is possible to easily specify the frame in which the identification information is included in the video.

A third embodiment is the game development support system according to the first embodiment, wherein the identification image includes an image of character information that indicates a number of frames at a game start or from a predetermined timing after the game start.

According to the third embodiment, since the identification image includes the image of character information indicative of the frame number, it is possible to specify the timing that the game image is output by the frame number.

A fourth embodiment is the game development support system according to the first embodiment, wherein the identification image includes an image of information that is located at a predetermined position of the game image at a predetermined timing after a game start, wherein the under-development game program causes the computer of the game apparatus to further execute outputting information that indicates a first timing that the image of information is located at the predetermined position of the game image.

According to the fourth embodiment, it is possible to specify the timing that the image of the information is arranged in the predetermined position of the game image by detecting the image of the information from the video and combining the image of the information with the information that indicates the timing of the outputted first.

A fifth embodiment is the game development support system according to the fourth embodiment, wherein the identification image includes a pattern image of a predetermined color.

According to the fifth embodiment, since it is sufficient to detect only the predetermined color, it is possible to detect the image of the information with a simple configuration.

A sixth embodiment is the game development support system according to the first embodiment, wherein the game apparatus generates the video data by capturing the game image, and the information processing apparatus receives the video data from the game apparatus.

A seventh embodiment is the game development support system according to the first embodiment, wherein the information processing apparatus generates the video data by capturing the game image.

An eighth embodiment is the game development support system according to the first embodiment, wherein the information processing apparatus acquires video data that the game image displayed a display device is imaged by an imaging device.

A ninth embodiment is the game development support system according to the first embodiment, wherein the under-development game program causes the computer of the game apparatus to further execute: detecting that a predetermined error occurs during execution of the game processing; generating the game image that includes the identification image when the predetermined error is detected; and transmitting video data of a predetermined time period that includes at least a timing that the game image including the identification image is generated in response to occurrence of the predetermined error to the information processing apparatus.

A tenth embodiment is a game development support method of a game development support system that comprises at least a game apparatus capable of executing an under-development game program and an information processing apparatus capable of an information processing program. The under-development game program causes a computer of the game apparatus to execute: outputting a log during execution of game processing, the log including timing information; and generating, within at least a predetermined period during execution of the game processing, a game image so that an identification image by which a timing that the game image is output is identifiable is included therein. The information processing program causes a computer of the information processing apparatus to execute: acquiring the log from the game apparatus; acquiring video data that is generated by capturing the game image; performing image analysis to the video data so as to specify a frame in which the identification image is included in the video, and to specify a timing that the game image in which the identification image is included is output; and generating, based on specified timing and the timing information included in the log, a viewing image that includes at least the log and the video that are displayed synchronously.

An eleventh embodiment is an information processing apparatus including one or more processors caused to execute: acquiring the log from the game apparatus game capable of executing an under-development game program; acquiring video data that is generated by capturing a game image that an identification image by which a timing that the game image is output is identifiable is included therein; performing image analysis to the video data so as to specify a frame in which the identification image is included in the video, and to specify a timing that the game image in which the identification image is included is output; and generating, based on specified timing and timing information included in the log, a viewing image that includes at least the log and the video that are displayed synchronously.

A twelfth embodiment is a non-transitory computer-readable storage medium having stored with an information processing program executable by an information processing apparatus comprising one or more processors, wherein the information processing program causes the one or more processors of the information processing apparatus to execute: acquiring the log from the game apparatus game capable of executing an under-development game program; acquiring video data that is generated by capturing a game image that an identification image by which a timing that the game image is output is identifiable is included therein; performing image analysis to the video data so as to specify a frame in which the identification image is included in the video, and to specify a timing that the game image in which the identification image is included is output; and generating, based on specified timing and timing information included in the log, a viewing image that includes at least the log and the video that are displayed synchronously.

According also to each of the tenth embodiment the eleventh embodiment and the twelfth embodiment, it is possible to reduce the time and effort required to confirm the operation of the under-development game program.

The features, aspects and advantages of the embodiment(s) will become more apparent from the following detailed description when taken in conjunction with the accompanying drawings.

### BRIEF DESCRIPTION OF THE DRAWINGS

FIG. 1 is a view showing a non-limiting example configuration of a game development support system according to a first embodiment.

FIG. 2 is a block diagram showing a non-limiting example electric configuration of a game apparatus shown in FIG. 1.

FIG. 3 is a block diagram showing a non-limiting example electric configuration of an information processing apparatus shown in FIG. 1.

FIG. 4 is a view showing a non-limiting example game screen displayed on a display device of the game apparatus shown in FIG. 1.

FIG. 5 is a view showing a non-limiting example viewing screen displayed on the display device of the information processing apparatus shown in FIG. 1.

FIG. 6 is a view showing a non-limiting example gap between a game time of a game program executed on the game apparatus and a recording time.

FIG. 7 is a view showing a non-limiting example game screen including an identification image.

FIG. 8 is a view showing a non-limiting example identification image included in a game screen.

FIG. 9 is a view showing a non-limiting example memory map of a RAM of the game apparatus shown in FIG. 2.

FIG. 10 is a view showing non-limiting example specific contents of a data storage area of the RAM shown in FIG. 9.

FIG. 11 is a view showing a non-limiting example memory map of a RAM of the information processing apparatus shown in FIG. 3.

FIG. 12 is a flowchart showing non-limiting example overall processing of a game program of a processor incorporated in the game apparatus shown in FIG. 2.

FIG. 13 is a flowchart showing a part of non-limiting example game image generation processing of the processor incorporated in the game apparatus shown in FIG. 2.

FIG. 14 is a flowchart showing another part of the non-limiting example game image generation processing of the processor incorporated in the game apparatus shown in FIG. 2, following FIG. 13.

FIG. 15 is a flowchart showing a part of non-limiting example analysis and specifying processing of a processor incorporated in the information processing apparatus shown in FIG. 3.

FIG. 16 is a flowchart showing another part of the non-limiting example analysis and specifying processing of the processor incorporated in the information processing apparatus shown in FIG. 3, following FIG. 15.

FIG. 17 is a flowchart showing non-limiting example viewing processing of the processor incorporated in the information processing apparatus shown in FIG. 3.

FIG. 18 is a view showing a non-limiting example identification image included in a game screen according to a second embodiment.

FIG. 19 is a flowchart showing a part of non-limiting example game image generation processing of the processor incorporated in the game apparatus according to the second embodiment.

FIG. 20 is a flowchart showing another part of the non-limiting example game image generation processing of the processor incorporated in the game apparatus according to the second embodiment.

FIG. 21 is a flowchart showing a part of non-limiting example analysis and specifying processing of the processor incorporated in the information processing apparatus according to the second embodiment.

FIG. 22 is a flowchart showing another part of the non-limiting example analysis and specifying processing of the processor incorporated in the information processing apparatus according to the second embodiment, following FIG. 21.

FIG. 23 is a flowchart showing a further part of the non-limiting example analysis and specifying processing of the processor incorporated in the information processing apparatus according to the second embodiment, following FIG. 22.

FIG. 24 is a view showing a non-limiting example configuration of a game development support system according to a third embodiment.

### DETAILED DESCRIPTION OF NON-LIMITING EXAMPLE EMBODIMENTS

### First Embodiment

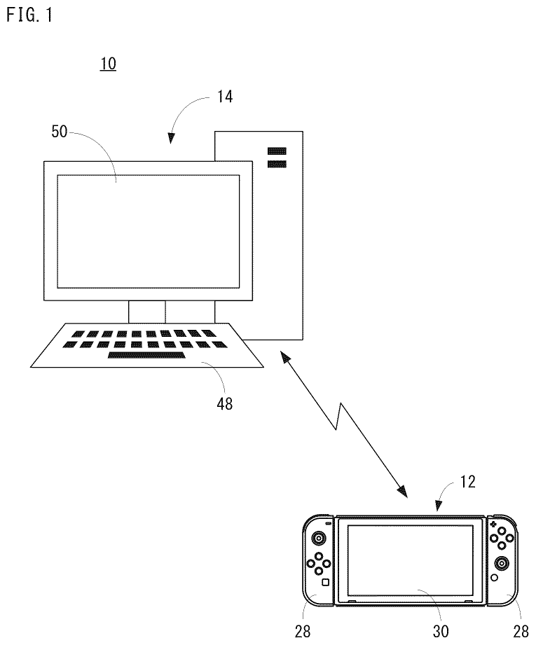

With reference to FIG. 1, a non-limiting example game development support system 10 comprises a game apparatus 12 and an information processing apparatus 14, and the game apparatus 12 and the information processing apparatus 14 are connected to each other communicably through a wire or wirelessly. Moreover, the game apparatus 12 and the information processing apparatus 14 are also connectable to each other through a LAN and/or a network such as the Internet.

The game apparatus 12 is a game apparatus that executes a game program of a virtual game under development. In this first embodiment, unless otherwise noted, a term “game program” means a game program under development rather than a product version of the game program. Similarly, a term “game apparatus” means a game apparatus for development that executes the under-development game program rather than a product version of the game apparatus.

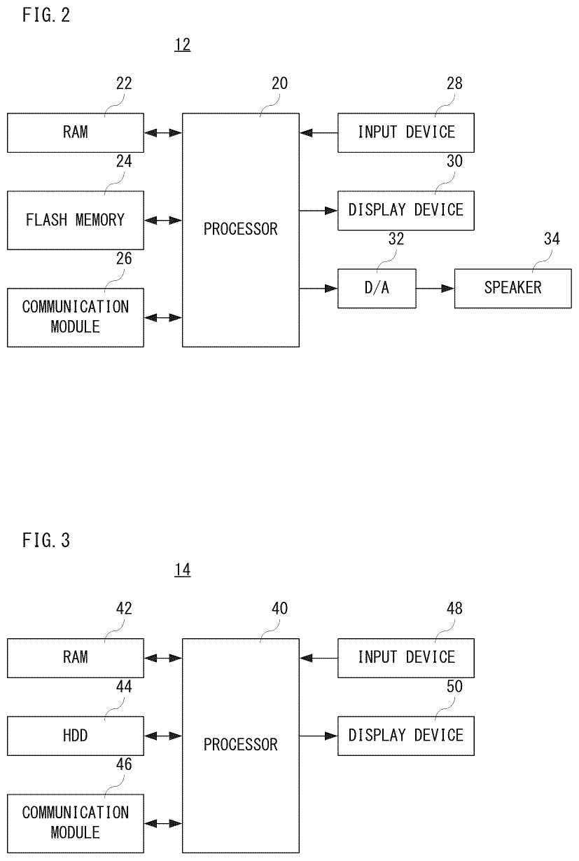

FIG. 2 is a block diagram showing a non-limiting example electric configuration of the game apparatus 12. As shown in FIG. 2, the game apparatus 12 comprises a processor 20, and the processor 20 is connected with a RAM 22, a flash memory 24, a communication module 26, an input device 28, a display device 30 and a D/A converter 32. Moreover, the D/A converter 32 is connected to a speaker 34.

The processor 20 is in charge of overall control of the game apparatus 12. Specifically, the processor 20 is an SoC (System-on-a-chip) that incorporates therein a plurality of functions, such as a CPU function, a GPU function, a video memory (VRAM), etc.

The RAM 22 is a volatile storage medium and is used as a working memory and a buffer memory for the processor 20. The flash memory 24 is a non-volatile storage medium, and is used in order to store a game program, store (save) various kinds of data, and so on.

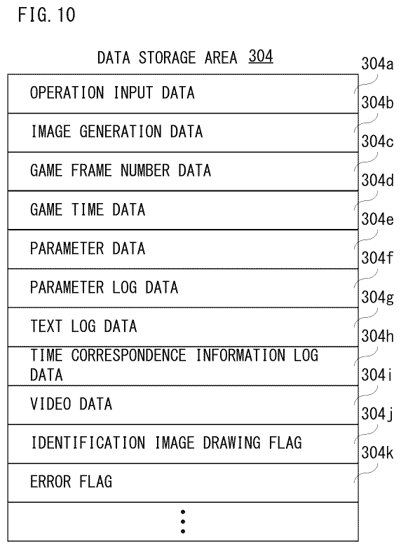

For example, the game program and required data are read from the flash memory 24 to be stored in the RAM 22. Moreover, a GPU that is incorporated in the processor 20 generates, in the VRAM (also referred to as “frame buffer”), image data for displaying various kinds of screens on the display device 30 with using image generation data 304b (see FIG. 10) that is stored in the RAM 22, and outputs generated image data to the display device 30.

The communication module 26 has a function that connects to a wireless LAN according to a system conforming to a standard of IEEE 802.11.b/g, for example. Therefore, the processor 20 transmits or receives data to or from a further apparatus via an access point and a network such as the Internet by using the communication module 26, for example. In the first embodiment, the further apparatus is the information processing apparatuses 14. Moreover, the communication module 26 may have also a function of connecting to a wired LAN. However, it is possible to directly transmit or receive data to or from the further apparatus using the communication module 26.

Moreover, unlike the function of connecting to a wireless LAN, the communication module 26 may have a function of performing a short-distance wireless communication. Specifically, the communication module 26 has a function that performs transmitting/receiving of an infrared ray signal with a further apparatus by a predetermined communication system (e.g., an infrared ray system), and a function that performs a wireless communication with the same kind of game apparatuses in accordance with a predetermined communication protocol (e.g., a multilink protocol). In this case, the processor 20 can directly transmit/receive data to or from other same kinds of game apparatuses by using the communication module 26, for example. However, instead of the short-distance wireless communication of the infrared ray system, a short-distance wireless communication according to a further wireless communication standard, such as Bluetooth (registered trademark) may be performed.

The input device 28 is a game controller provided with various kinds of push buttons, keys or switches that are provided on the game apparatus 12, for example, and is used by a user or a player (hereinafter, simply referred to as “player”) for various kinds of operations, such as menu selection, instructions in an application. For example, the game controller is provided with an A button, a B button, an X button, a Y button, an L button, an R button, a cross button (and/or a slide stick), etc. However, in a case of a portable game apparatus 12, in addition to the push buttons, keys or switched, a touch panel may be provided as the input device 28.

The display device 30 is display device such as an LCD or an organic EL. However, when the game apparatus 12 is a game apparatus of a stationary type, the display device 30 may be provided separately from an apparatus main body of the game apparatus 12.

The D/A converter 32 converts sound data given by the processor 20 into an analog audio signal, and outputs the same to the speaker 34. However, the sound data may be data of sound, such as a sound generated by a character or object, a sound effect and BGM.

In addition, the electric configuration of the game apparatus 12 shown in FIG. 2 is a mere example, and should not need to be limited to this. For example, the input device 28 may be provided as a separated body from the apparatus main body of the game apparatus 12, and may be communicably connected to the processor 20. Moreover, the game apparatus 12 may be constituted so that an external memory such as an optical disc, a USB memory or a memory card is attachable to or detachable from the game apparatus 12.

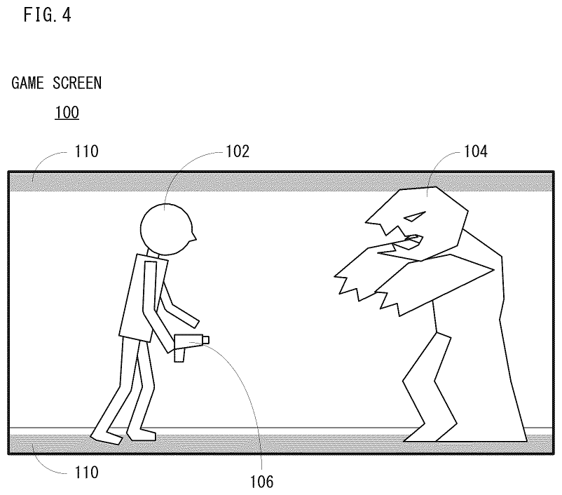

Moreover, the information processing apparatus 14 may be a general-purpose personal computer, a tablet terminal or a server. FIG. 3 is a block diagram showing a non-limiting example electric configuration of the information processing apparatus 14. As shown in FIG. 3, the information processing apparatus 14 comprises a processor 40, and the processor 40 is connected with a RAM 42, an HDD 44, a communication module 46, an input device 48 and a display device 50.

The processor 40 is in charge of overall control of the information processing apparatus 14. Specifically, the processor 40 is an SoC that incorporates therein a plurality of functions, such as a CPU function, a GPU function and a VRAM.

The RAM 42 is a volatile storage medium and is used as a working memory and a buffer memory for the processor 40. The HDD 44 is a non-volatile storage medium, and is used in order to store an information processing program for executing outputs of a log, video data, etc., and save various kinds of data.

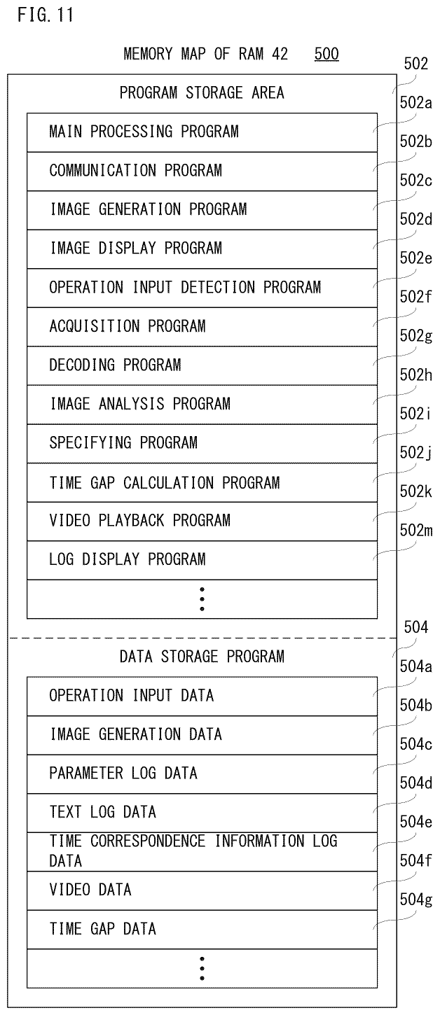

For example, the information processing program and required data are read from the HDD 44 to be stored in the RAM 42. Moreover, a GPU that is incorporated in the processor 40 generates, in the VRAM, image data for displaying various kinds of screens on the display device 50 with using image generation data 504b (see FIG. 11) that is stored in the RAM 42, and outputs generated image data to the display device 50.

The communication module 46 has the same function as the communication module 26 shown in FIG. 2, and transmits or receives data to or from the game apparatus 12. The input device 48 may be constituted with a keyboard, a computer mouse, a touch panel, etc. as an example. When the information processing device 14 is a tablet terminal, the input device 48 can be configured with hardware buttons and a touch panel provided on an apparatus main body of the information processing device 14.

The display device 50 is a display device such as an LCD or an organic EL. However, when the information processing apparatus 14 is a personal computer or server of a stationary type, the display device 50 may be provided separately from the apparatus main body of the information processing apparatus 14.

In addition, the electric configuration of the information processing apparatus 14 shown in FIG. 3 is a mere example, and does not need to be limited to this. For example, the information processing apparatus 14 may be further provided with a speaker. Moreover, the information processing apparatus 14 may be constituted so that an external memory such as an optical disc, a USB memory or a memory card is attachable to or detachable from the information processing apparatus 14.

As an example, the game program is a game program of a virtual game such as an action game in which a player character object is moved in a virtual space, fights with an enemy character object, acquires an item or uses an item according to an operation of the player.

FIG. 4 is a view showing a non-limiting example game screen 100 when executing a game program. In the game screen 100 shown in FIG. 4, a player character object 102 and an enemy character object 104 are displayed in a state of facing each other. Moreover, the player character object 102 has a gun object 106. A background object is indicated with omitting others except the ground.

The game screen 100 is also a game image under development displayed when the game program is being executed, and internal information of the game program is displayed in at least one area 110 of an upper area and a lower area of the game screen 100, the internal information being information not displayed in a game image of a case where a product version of the game program is executed. The internal information includes the usage rates of the CPU and GPU, the degree of memory occupancy, the operation information by the player, the degree of progress of the virtual game, the total time spent playing the virtual game (i.e., the total play time), etc. In FIG. 4, in order to show the area 110 intelligibly, the area 110 is smeared away in gray.

Moreover, in the game apparatus 12, during execution of processing of the game program (overall processing, described later), a log of various kinds of parameters used for this overall processing (hereinafter, referred to as “parameter log”) is generated. Such various kinds of parameters include parameters that indicate the property and pump performance of the character objects appearing in the virtual game, and specifically, include an HP, a level, kinds and numbers of possessed items, a moving speed, acceleration, various kinds of flags, etc. of the character object (here, the player character object 102).

Furthermore, in the game apparatus 12, during execution of the overall processing of the game program, a log in a text form or a binary form of various kinds of parameters used for the overall processing (text log) is generated. The text log is a log for displaying a name (or contents), a numerical value, etc. for each of the various kinds of parameters by a character string.

The parameter log and the text log are generated for each frame (hereinafter, referred to as “game frame”). Moreover, the number of the game frames from the time that the overall processing of the game program is started (i.e., at a time of game start) (hereinafter, referred to as “game frame number”) is added to the parameter log and the text log, respectively. Moreover, the parameter log and the text log are stored from the start to the end of the overall processing of the game program. The time of game start is a time of starting (running) the game program managed by the firmware or OS of the game apparatus 12.

However, the game frame number may be the number of the frames from a predetermined timing after the game start. Moreover, the game frame is a unit time for updating the screen of the game apparatus 12, and is set as 1/60 seconds as an example. The game frame may be set to 1/30 seconds or 1/120 seconds.

Moreover, if the execution of the overall processing of the game program is started, the execution of a capture function of the game apparatus 12 is instructed, so that the game screen 100 is captured from the start to the end of the virtual game. That is, the video data is generated. As an example, a file format of the video data is MP4.

In this embodiment, the parameter log, the text log and the video data for each game frame are output (transmitted) to the information processing apparatus 14, and the information processing apparatus 14 acquires (receives) the parameter log, the text log and the video data.

However, this is an example, and the game apparatus 12 may transmit all the parameter logs, the text log and the video data from the game start to the game end to the information processing apparatus 14 after the game end.

Moreover, in another example, the game apparatus 12 may store the parameter log, the text log and the video data in a storage medium such as a memory card or an external HDD to allow the information processing apparatus 14 acquire from this storage medium the parameter log, the text log and the video data.

Moreover, the game image data generated by the game apparatus 12 may be transmitted to the image processing apparatus 14, so that the video data can be generated by capturing the game image data by a capture device connected to the information processing apparatus 14.

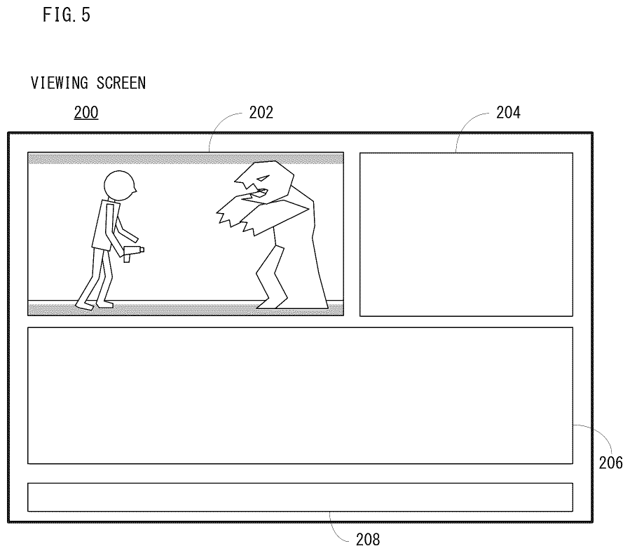

FIG. 5 is a view showing a non-limiting example viewing screen 200 displayed on the display device 50 of the information processing apparatus 14. The viewing screen 200 shown in FIG. 5 includes display areas 202, 204, 206 and 208. As an example, in the viewing screen 200, the display areas 202 and 204 are provided side by side in an upper part of the screen, the display area 206 is provided blow these, and the display area 208 is provided further below.

The display area 202 is with the video or moving image that the video data is played-back. The display area 204 is displayed with the text log. The display area 206 is displayed with the parameter log. The display area 208 is provided with an operation panel.

However, in FIG. 5, the parameter log, the text log and the operation panel are omitted. The parameter log and the text log are as described above. The operation panel is provided with a plurality of icons for playing-back, stopping, fast forwarding or reversing the video, and is provided with a slide button for determining a playback position of the video.

In such a viewing screen 200, if the video is played-back, the parameter log and text log of a game frame corresponding to a frame (hereinafter, referred to as “video frame”) of the video that is being displayed are displayed according to an operation by a developer at al., respectively.

In addition, although illustration is omitted, in the viewing screen 200 of an initial period when starting the viewing, the display areas 202, 204 and 206 are in a state of being not displayed at all.

However, since no information of a timing that the game image is to be displayed, i.e., the game frame number is usually not included in the video, it is difficult to display the parameter log and the text log, and the video synchronously.

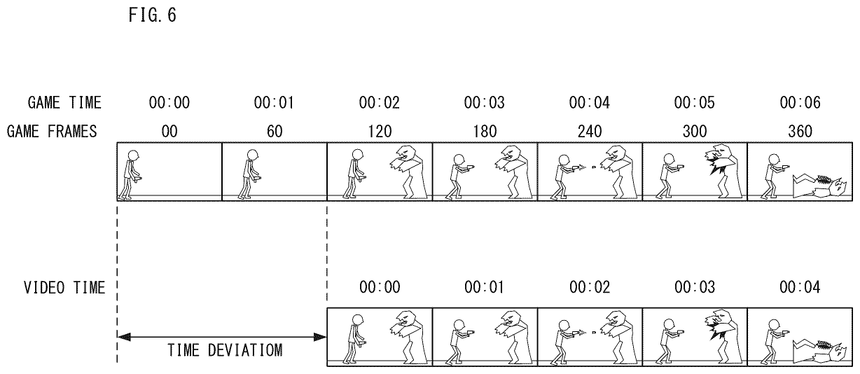

FIG. 6 is a view showing a non-limiting example gap or deviation between the game frame and the recording time. In FIG. 6, a change of the game image according to progress of a game frame number, i.e., an elapsed time (hereinafter, referred to as “game time”) from the game start is indicated in an upper row. Briefly describing, when the player character object 102 is moved to a right direction according to an operation of the player, the enemy character object 104 will appear from the front of the player character object 102. The player character object 102 attacks the enemy character object 104 using the gun object 106 according to an operation of the player, and a bullet fired from the gun object 106 hits the enemy character object 104, and then, the enemy character object 104 is fallen down. However, a plurality (here, for 59 game frames) of game images between two adjacent game images in the upper row of FIG. 6 are omitted.

Moreover, in a lower row in FIG. 6, a change of the video according to a video frame number form a start of recording, i.e., according to progress of the elapsed time (hereinafter, referred to as “recording time”), that is, a change of the game image that is captured (hereinafter, referred to as “captured image”) is indicated. However, a plurality (here, for 59 video frames) of captured images between two adjacent captured images in the lower row in FIG. 6 are omitted.

In addition, in the example shown in FIG. 6, in order to show intelligibly, a frame rate of the game image and a frame rate of the video are set to be the same, and are fixed, respectively. However, the frame rate of the game image may be changed during the execution of the game program.

For example, even if execution of the capture is instructed at the same time that the overall processing of the game program is started, it takes time until the capture of the game image is actually started, and a gap may occur between the game time and the recording time. In the example shown in FIG. 6, when the game frame number from the game start is 120, i.e., when the game time is 2 (two) seconds, the recording time is 0 (zero) second and the gap for 2 (two) seconds occurs. Conversely, there may be cases where the capture of the game image is started first.

Therefore, even if an output of the parameter log and the text log is started at the same time that the playback of the video data is started, the number of game frames rarely matches between the parameter log and the text logs, and the video.

Therefore, in this embodiment, in a predetermined case, by displaying a game image including an identification image by which a timing that the game image is output is identifiable, and making the video data include an identification image, in the viewing screen 200, the logs and the video are made to be synchronized.

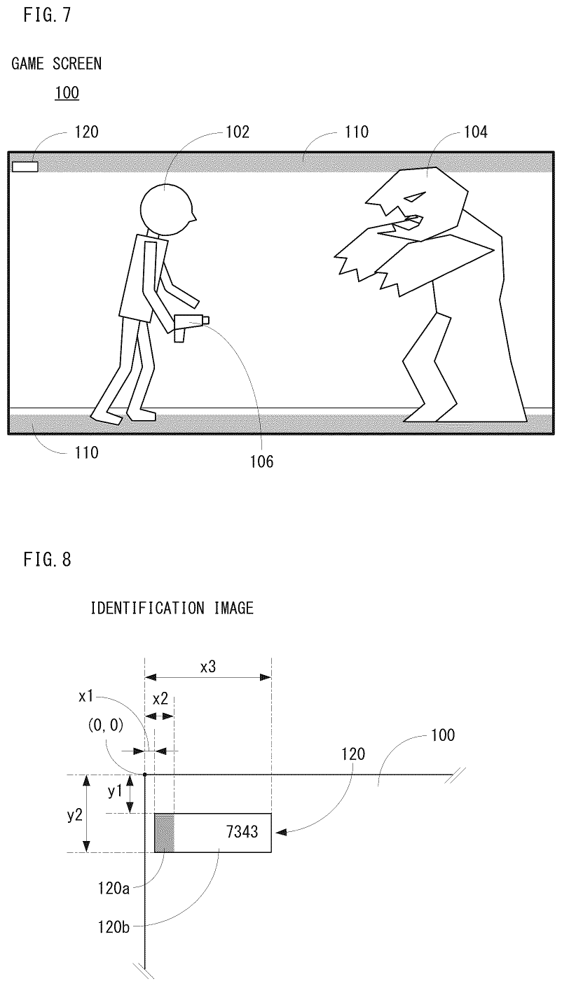

FIG. 7 is a view showing a non-limiting example game screen 100 including the identification image. In the game screen 100 shown in FIG. 7, a display area 120 of the identification image is provided in an upper part at the left of the screen. That is, the identification image is located in a predetermined position of the game image. In the first embodiment, the identification image is an image of a marker of a predetermined color (e.g., green) and a character string indicative of the game frame number from the game start. Moreover, the identification image is displayed (or drawn) only for a first predetermined time period (in the first embodiment, 1.1 seconds).

FIG. 8 is an enlarged view that the upper left part of the game screen 100 is enlarged. As shown in FIG. 8, the display area 120 includes a display area 120a and a display area 120b. The display area 120a is an area for displaying the green marker. The display area 120b is an area except the display area 120a out of the display area 120, and is an area for displaying the character string of the game frame number. In FIG. 7 and FIG. 8, in order to show the display area 120 intelligibly, a square frame is displayed, but in an actual game screen 100, it is not necessary to display such a square frame. Moreover, in FIG. 8, in order to distinguish the display area 120a and the display area 120b from each other, the display area 120a is smeared away in gray.

On the assumption that an upper left vertex of the game screen 100 is set as an origin point (0, 0), the display area 120a is determined in a range from the length x1 to the length x2 in the horizontal direction and a range from the length y1 to the length y2 in the vertical direction. Moreover, the display area 120b is determined in a range from the length x2 to the length x3 in the horizontal direction and a range from the length y1 to the length y2 in the vertical direction. However, the length x1, x2, x3, y1 and y2 are respectively represented by the number of the pixels at the time of generating the game image data corresponding to the game screen 100 in the VRAM.

Moreover, the predetermined case includes a case where the capture of the game screen 100 is started at the time of the game start and a case where an error occurs during the execution of the game program. An error is determined in the overall processing of the game program, and specifically, an error is determined when the player character object 102 is positioned in a place should not exist.

The video data is generated from the game start to the game end. Moreover, when an error occurs, video data is generated using the video data from the game start to the game end, which includes the captured image including, in the tail, the identification image displayed (or drawn) due to the occurrence of the error, and a position backed a second predetermined time (e.g., 5 (five) minutes) from the tail becomes the head. In addition, video data for a portion that an error occurs is generated by the developer et al.

Therefore, in the video data, the identification image is included in a portion that includes the head or a portion that includes the tail. Therefore, in the information processing apparatus 14, when the log and the video are viewed, in advance of the viewing, the video data is analyzed and the identification image included in the video data is detected.

However, parallel processing may be executed to simultaneously perform the analysis while the video is being viewed. In this case, the video is viewed in a manner not synchronizing with the log until the analysis is completed.

In processing of analyzing the video data (hereinafter, referred to as “image analysis processing”), the video data is scanned for a third predetermined time period (e.g., 30 seconds) including the head of the video data and for the third predetermined time period including the tail of the video data, so that the identification image that is included in the video frames constituting the video data is detected. Furthermore, the recording time of the video frame including the detected identification image and its corresponding game frame number are specified.

Specifically, in advance of the image analysis processing, the video data is decoded according to the file format of MP4. In the image analysis processing, the image data corresponding to the head video frame of the decoded video data is expanded into the VRAM, and it is determined whether the green marker is drawn within the range corresponding to the display area 120a out of the image data having been expanded into the VRAM. That is, it is determined whether a color value (i. e., value of RGB) of the pixel within the range corresponding to the display area 120a indicates a green color.

If the green marker is detected within the range corresponding to the display area 120a, character recognition processing is performed within the range corresponding to the display area 120b. Specifically, in the range corresponding to the display area 120b, OCR processing is performed. Since the OCR processing is well-known technology, a description thereof is omitted. Therefore, the game frame number included in the image data expanded into the VRAM is recognized or detected. Therefore, the recording time of the video frame corresponding to the image data that is expanded into the VRAM and its corresponding game frame number are specified.

On the other hand, if the green marker is not detected within the range corresponding to the display area 120a, it is determined whether the green marker is drawn for the video frame a predetermined number (e.g., five (5)) ahead. That is, the video data is scanned while skipping the video frames. This is for reducing the processing load of image analysis processing. Therefore, it is possible to scan the video data without skipping the video frames.

If the green marker is not detected when scanning the video data of 30 seconds from the head, the video data is scanned from a position 30 seconds before the tail to the tail (hereinafter, referred to as “tail 30 seconds”). The scan of the tail 30 seconds of the video data is the same as the scan of 30 seconds including the head video frame.

Since the identification image is drawn in the display area 120 in a predetermined position in the game image, only a range corresponding to this display area 120 in the image analysis processing may be searched, and therefore, it is possible to easily specify or detect the video frame corresponding to the image data including the identification image. Moreover, since the identification image is a character string of the game frame number, in the game apparatus 12, it is possible to specify the timing that the identification image is drawn as the game frame number.

In addition, although it is determined whether the green marker is drawn within the range corresponding to the display area 120a in the first embodiment, it may be determined whether the green marker is drawn within a first predetermined range that includes the range corresponding to the display area 120a. As an example, the first predetermined range has a size approximately 1.2 times to 2 times a size of the range corresponding to the display area 120a. Similarly, although the character recognition processing is executed within the range corresponding to the display area 120b, the character recognition processing may be executed within a second predetermined range that includes the range corresponding to the display area 120b. As an example, the second predetermined range has a size approximately 1.2 times to 2 times a size of the range corresponding to the display area 120b.

If the recording time and its corresponding game frame number are specified, based on these pieces of information, the viewing screen 200 is displayed while synchronizing the video data and the log with each other. Here, it will be described how to synchronize the video data and the log with each other.

There is an occasion that the frame rate is changed according to the processing load of the processor 20 during the execution of the game program. In order to correspond to such a change of the frame rate, i.e., a variable frame rate, the game time corresponding to the game frame number specified by analyzing the video data is further specified, and a gap of the recording time (hereinafter, referred as “time gap”) specified by analyzing the video data with respect to the specified game time is calculated (or specified), and then, viewing image data for the viewing screen 200 that the video data and the log are synchronized with each other is generated using the calculated time gap. As an example, the time gap is calculated by subtracting the specified recording time from the specified game time. Therefore, if the start of recording is later than the start of the game, the time gap is a positive value, and if the start of recording is earlier than the start of the game, the time gap is a negative value.

Moreover, in order to specify the game time corresponding to the game frame number as described above, during the execution of the game program, a log of the game time corresponding to the game frame number, i.e., information of an elapsed time from the game start (hereinafter, referred to as “time correspondence information”) is generated, and the log of the time correspondence information (hereinafter, referred to as “time correspondence information log”) is output to the information processing apparatus 14. In order to generate the log of the game time corresponding to the game frame number, the game time is counted with a unit of micro (μ) second.

However, the game apparatus 12 may transmit, after the game end, all of the time correspondence information log from the game start to the game end to the information processing apparatus 14 together with all of the parameter log, the text log and the video data from the game start to the game end.

Alternatively, the game apparatuses 12 may store in the storage medium such as a memory card or an external HDD the time correspondence information log together with the parameter log, the text log and the video data to allow the information processing apparatus 14 acquire from this storage medium the parameter log, the text log, the video data and the time correspondence information log.

When the viewing processing is started by the developer et al., the viewing screen 200 is displayed on the display device 50 of the information processing apparatus 14. Moreover, if the playback is instructed by the developer et al. using the operation panel displayed in the display area 208 of the viewing screen 200, the playback of the video is started, and the display of the parameter log and the text log is started along with the video. Although the video is basically played-back from the head, if the developer et al. designate the playback position, the video is played-back from the designated playback position.

During the playback of the video, the game time corresponding to the current recording time (hereinafter, referred to as “current time”) of the video data is calculated using the time gap. The game time is calculated by adding the time gap to the current time. When the game time is calculated, the parameter log and the text log of the game frame number corresponding to the calculated game time are displayed.

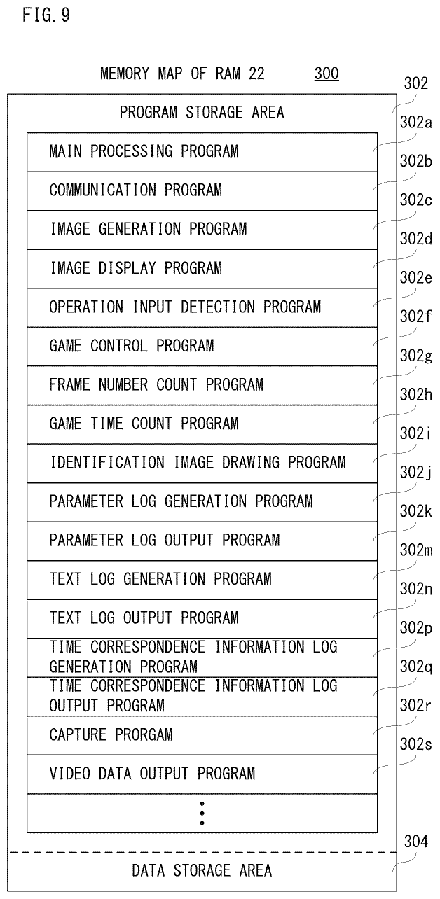

FIG. 9 is a view showing a non-limiting example memory map 300 of the RAM 22 of the game apparatus 12 shown in FIG. 2. As shown in FIG. 9, the RAM 22 includes a program storage area 302 and a data storage area 304. The program storage area 302 is stored with a game program according to the first embodiment. The game program includes a main processing program 302a, a communication program 302b, an image generation program 302c, an image display program 302d, an operation input detection program 302e, a game control program 302f, a frame number count program 302g, a game time count program 302h, an identification image drawing program 302i, a parameter log generation program 302j, a parameter log output program 302k, a text log generation program 302m, a text log output program 302n, a time correspondence information log generation program 302p, a time correspondence information log output program 302q, a capture program 302r, a video data output program 302s, etc.

In addition, the game program may be stored in advance in the flash memory 24, or may be acquired from the external memory attachable to or detachable from the game apparatus 12, such an optical disk, a USB memory or a memory card. However, a part of the game program is stored in the flash memory 24, and other parts thereof may be acquired from the external memory. These are the same also about the image generation data 304b described later.

The main processing program 302a is a program for processing a main routine of the game program of the first embodiment.

The communication program 302b is a program for communicating with an external apparatus, the information processing apparatus 14 in the first embodiment.

The image generation program 302c is a program for generating (drawing), using the image generation data 304b, game image data corresponding to the game screen 100, i.e., the game image. When it is determined that the identification image is to be drawn, the game image data including the image data of the identification image is generated. However, if it is not determined that the identification image is to be drawn, the game image data not including the image data of the identification image is generated.

The image display program 302d is a program for outputting the game image data generated according to the image generation program 302c to the display device 30. Therefore, the game screen 100 is displayed on the display device 30.

The operation input detection program 302e is a program for detecting the operation input data 304a to an operation input portion by the player. In the first embodiment, the operation input portion is various kinds of push buttons, keys or switched provided on the input device 28.

The game control program 302f is a program for performing the game control processing of the virtual game of the first embodiment.

The frame number count program 302g is a program for counting the game frame number from the game start.

The game time count program 302h is a program for counting the game time from the game start.

The identification image drawing program 302i is a program for determining whether the identification image (in the first embodiment, the green marker and the game frame number) is to be drawn.

The parameter log generation program 302j is a program for generating the parameter log for each game frame.

The parameter log output program 302k is a program for outputting the parameter log generated according to the parameter log generation program 302j. In the first embodiment, the parameter log is output to the information processing apparatus 14. The communication program 302b is also executed at this time.

The text log generation program 302m is a program for generating the text log for each game frame.

The text log output program 302n is a program for outputting the text log generated according to the text log generation program 302m. In the first embodiment, the text log is output to the information processing apparatus 14. The communication program 302b is also executed at this time.

The time correspondence information log generation program 302p is a program for generating the time correspondence information log for each game frame.

The time correspondence information log output program 302q is a program for outputting the time correspondence information log generated according to the time correspondence information log generation program 302p. In the first embodiment, the time correspondence information log is output to the information processing apparatus 14. The communication program 302b is also executed at this time.

The capture program 302r is a program for capturing the game image to generate the video data.

The video data output program 302s is a program for outputting the video data generated according to the capture program 302r. In the first embodiment, the video data is output to the information processing apparatus 14. The communication program 302b is also executed at this time.

Although illustration is omitted, the program storage area 302 is stored with other programs, such as a sound output program for generating and outputting a required sound in a virtual game, a program for changing a direction of the virtual camera according to the operation input of the player, etc. Moreover, firmware or OS, middleware, etc. are stored in the program storage area 302.

FIG. 10 is a view showing non-limiting example specific contents of the data storage area 304 of the RAM22 shown in FIG. 9. As shown in FIG. 10, the data storage area 304 is stored with the operation input data 304a, the image generation data 304b, the game frame number data 304c, game time data 304d, parameter data 304e, parameter log data 304f, text log data 304g, time correspondence information log data 304h, the video data 304i, an identification image drawing flag 304j, an error flag 304k, etc.

The operation input data 304a is data that is input from the input device 28, and is stored according to a time series. The operation input data 304a is eliminated if used for processing of the processor 20.

The image generation data 304b includes data for generating the game image data, such as polygon data and texture data.

The game frame number data 304c is data of the game frame number counted from the game start.

The game time data 304d is data of the game time counted by a unit of micro (μ) second from the game start.

The parameter data 304e is data of various kinds of parameters, and is updated by the game control processing.

The parameter log data 304f is data of the parameter log generated in the current game frame, and is updated for each game frame.

The text log data 304g is data of the text log generated in the current game frame, and is updated for each game frame.

The time correspondence information log data 304h is data of the time correspondence information log generated in the current game frame, and is updated for each game frame.

The video data 304i is data of the game image that is captured in the current game frame, and is updated for each video frame.

The identification image drawing flag 304j is a flag for determining whether the identification image is to be drawn. The identification image drawing flag 304j is turned on when it is determined that the identification image is to be drawn according to the identification image drawing program 302i. The identification image drawing flag 304j is turned off when it is determined that the identification image is not to be drawn according to the identification image drawing program 302i.

The error flag 304k is a flag for determining whether the identification image is to be drawn due to occurrence of an error. The error flag 304k is turned on when the identification image is to be drawn due to occurrence of an error, and the error flag 304k is turned off when the identification image is not to be drawn due to occurrence of an error.

Although illustration is omitted, the data storage area 304 is stored with other data required for the execution of the game program, and is provided with a counter(s) or a timer(s). For example, data of respective non-player objects in the virtual space, such as an enemy character object 104, etc., and parameter data of the respective background objects and the virtual camera, etc. are stored.

FIG. 11 is a view showing a non-limiting example memory map 500 of the RAM 42 of the information processing apparatus 14 shown in FIG. 3. As shown in FIG. 11, the RAM 42 includes a program storage area 502 and a data storage area 504. The program store area 502 is stored with an information processing program of the first embodiment. The information processing program includes a main processing program 502a, a communication program 502b, an image generation program 502c, an image display program 502d, an operation input detection program 502e, an acquisition program 502f, a decode program 502g, an image analysis program 502h, a specifying program 502i, a time gap calculation program 502j, a video playback program 502k, a log display program 502m, etc.

In addition, the image processing program may be stored in advance in the HDD 44, or may be acquired from the external memory attachable to or detachable from the information processing apparatus 14, such an optical disk, a USB memory or a memory card. However, a part of the information processing program is stored in the HDD 44, and other parts thereof may be acquired from the external memory. These are the same also about the image generation data 504b described later.

The main processing program 502a is a program for processing a main routine of the image processing program of the first embodiment.

The communication program 502b is a program for communicating with an external apparatus, the game apparatus 12 in the first embodiment.

The image generation program 502c is a program for generating (drawing), using image generation data 504b, parameter log data 504c, text log data 504d and video data 504f, viewing image data corresponding to the viewing screen 200.

The image display program 502d is a program for outputting the viewing image data generated according to the image generation program 502c to the display device 50. Therefore, the viewing screen 200 is displayed on the display device 50.

The operation input detection program 502e is a program for detecting operation input data 504a to an operation input portion by the developer et al. In the first embodiment, the operation input portion is various kinds of push buttons, keys or switched provided on the input device 48.

The acquisition program 502f is a program for acquiring parameter log data 504c, text log data 504d, time correspondence information log data 504e and the video data 504f. In the first embodiment, a parameter log, a text log and a video that are received from the game apparatus 12 according to the communication program 502b are acquired.

The decode program 502g is a program for decoding the video data 504f acquired from the game apparatus 12. However, when decoding the video data 504f, a decode program included in a video playback program 502k may be used.

The image analysis program 502h is a program for detecting, by scanning the decoded video data 504f and detecting the identification image included in the image data corresponding to the video frame that constitutes the video data 504f, the game frame number from the detected identification image.

The specifying program 502i is a program for specifying the recording time and its corresponding game frame number of the video frame corresponding to the image data that the game frame number is detected.

The time gap calculation program 502j is a program for calculating (or specifying) a time gap by specifying the game time corresponding to the game frame number specified according to the specifying program 502i.

The video playback program 502k is a program for playing-back the video. The log display program 502m is a program for displaying, using the time gap calculated according to the time gap calculation program 502j, the parameter log and the text log synchronously with the video. When performing the playback of the video and the display of the log, the image generation program 502c and the image display program 502d are also executed.

Although illustration is omitted, the program storage area 502 is stored with other programs required in the information processing. Moreover, OS, middleware, etc. are also stored in the program store area 502.

Moreover, the data storage area 504 is stored with the operation input data 504a, the image generation data 504b, the parameter log data 504c, the text log data 504d, the time correspondence information log data 504e, the video data 504f and time gap data 504g.

The operation input data 504a is data that is input from the input device 48, and is stored according to a time series. The operation input data 504a is eliminated if used for processing of the processor 40. The image generation data 504b includes data for generating viewing image data.

The parameter log data 504c is the parameter log data 304f from the game start to the game end acquired from the game apparatus 12.

The text log data 504d is the text log data 304g from the game start to the game end acquired from the game apparatus 12.

The time correspondence information log data 504e is the time correspondence information log data 304h from the game start to the game end acquired from the game apparatus 12.

The video data 504f is the video data 304i from the game start to the game end acquired from the game apparatus 12. Moreover, the video data 504f may be video data of a portion in which an error occurs, which is generated using the video data 304i from the game start to the game end acquired from the game apparatus 12.

The time gap data 504g is data of the time gap calculated according to the time gap calculation program 502j.

Although illustration is omitted, the data storage area 504 is stored with other data required for the information processing, and is provided with a counter(s) or a timer(s).

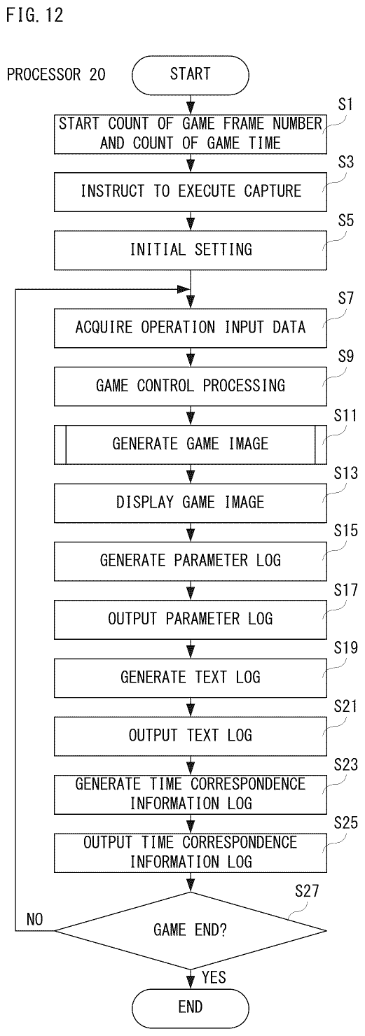

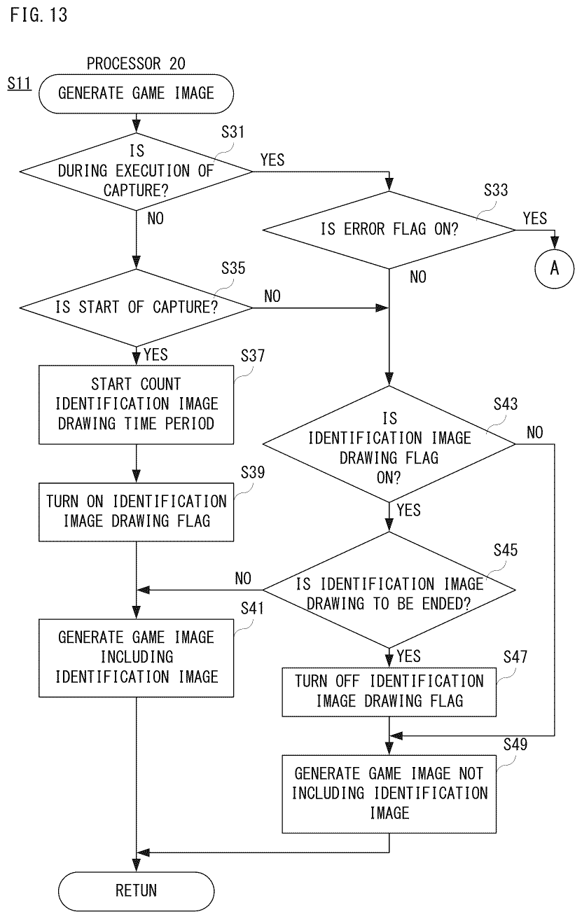

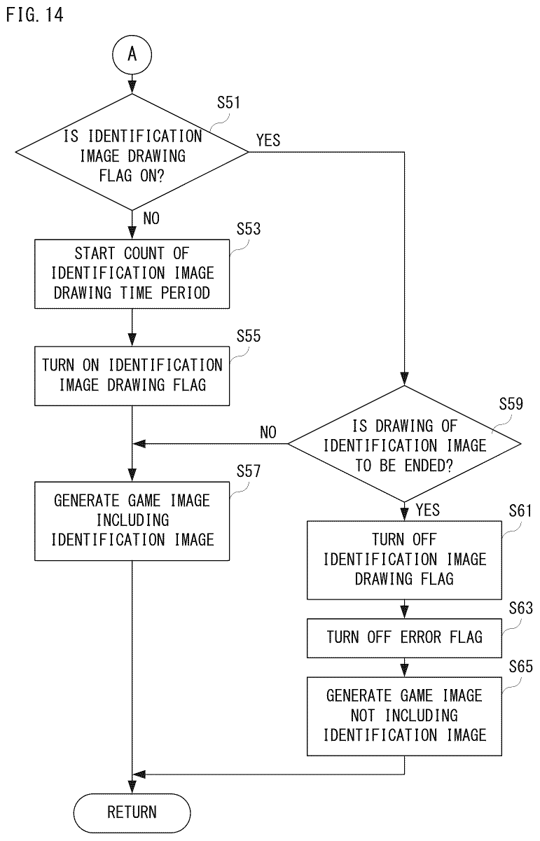

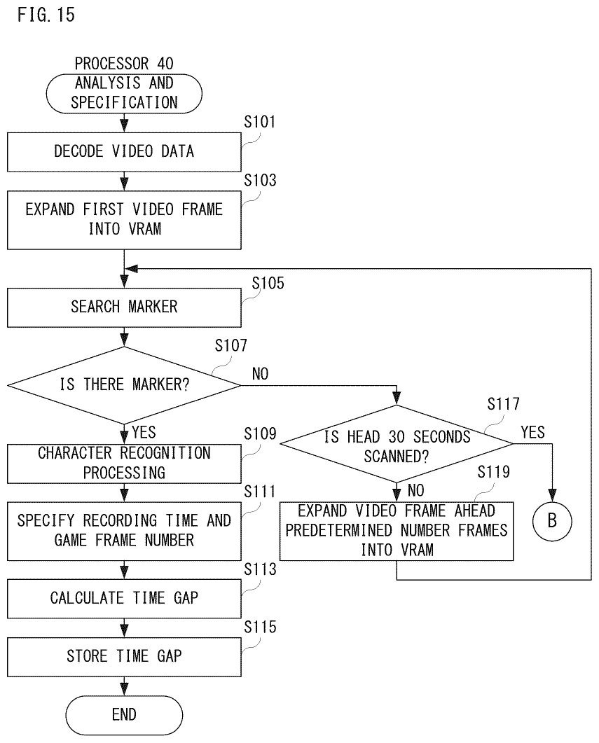

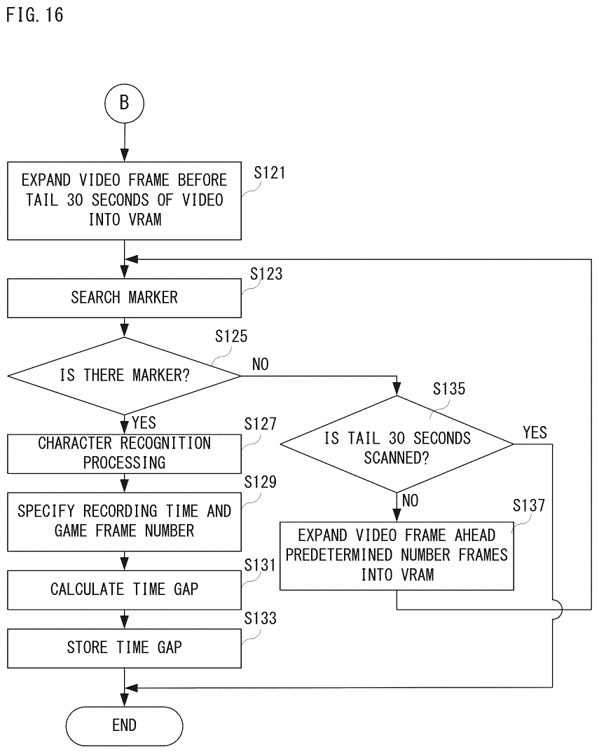

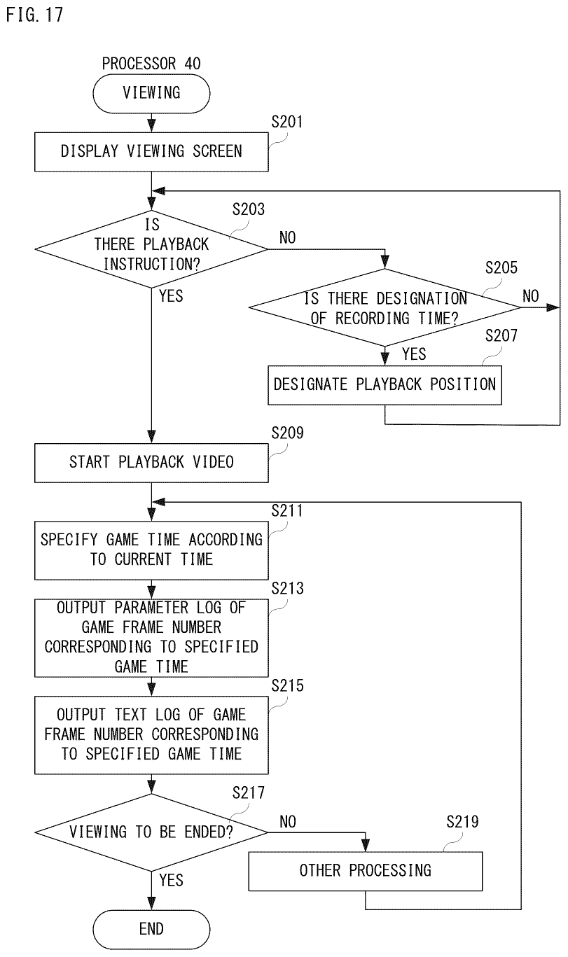

FIG. 12 is a flowchart showing non-limiting example processing of the game program (overall processing) of the processor 20 shown in FIG. 2. FIG. 13 and FIG. 14 are flowcharts showing non-limiting example game image generation processing of the processor 20 shown in FIG. 2. FIG. 15 and FIG. 16 are flowcharts showing non-limiting example analysis and specifying processing of the processor 40 shown in FIG. 3. FIG. 17 is a flowchart showing non-limiting example viewing processing of the processor 40 shown in FIG. 3.

However, processing of respective steps of the flowcharts shown in FIG. 12-FIG. 17 are mere examples, and if the same or similar result is obtainable, an order of the respective steps may be exchanged. Moreover, in the first embodiment, it will be described that the processing of the respective steps of the flowcharts shown in FIG. 12-FIG. 14 are basically executed by the processor 20; however, some steps may be executed by a processor(s) and/or a dedicated circuit(s) other than the processor 20. Similarly, it will be described that the processing of the respective steps of the flowcharts shown in FIG. 15-FIG. 17 are basically executed by the processor 40; however, some steps may be executed by a processor(s) and/or a dedicated circuit(s) other than the processor 40.

In the following, the overall processing and the game image generation processing will be described with reference to FIG. 12-FIG. 14, and with reference to FIG. 15-FIG. 17, the analysis and specifying processing and the viewing processing will be described; however, as to the same or similar contents of processing, a duplicate description will be omitted.

When the power of the game apparatus 12 is turned on, prior to execution of the overall processing, the processor 20 executes a boot program stored in a boot ROM not shown, whereby respective units including the RAM 22, etc. are initialized. When the execution of the game program of the first embodiment is instructed by the player, the game apparatus 12 will start the overall processing.

As shown in FIG. 12, if the overall processing is started, the processor 20 starts, in a step S1, the count of the game frame number and the game time, and in a step S3, instructs to execute the capture. Although illustration is omitted, the processor 20 executes the capture processing in parallel to the overall processing. The capture processing is processing that performs the capture of the game screen 100 displayed on the display device 30, i.e., the game image, and generates the video data 304i of the captured game image. Moreover, the generated video data 304i is output to information processing apparatus 14. Therefore, the information processing apparatus 14 acquires the video data 304i for each video frame.

In a next step S5, the initial setting is executed. Here, the processor 20 determines positions and directions that the player character object 102, the non-player objects (including the enemy character object 104), the respective background objects and the virtual camera are to be arranged as initial positions and initial directions, in the virtual space. Moreover, the processor 20 sets initial values to various kinds of parameters.

In a subsequent step S7, the operation input data transmitted or inputted from the input device 28 is acquired, and in a step S9, the game control processing is executed. The processor 20 makes, in the game control processing, the player character object 102 perform an arbitrary action, and acquire or use an item according to an operation of the player. Moreover, the processor 20 makes, in the game control processing, the enemy character object 104 appear, and perform an arbitrary action such as attacking the player character object 102, etc., and an item appear, regardless of an operation of the player. Furthermore, when the game control processing is executed, the parameter data 304e is updated.

In a next step S11, game image generation processing described later (see FIG. 13 and FIG. 14). Briefly describing, the processor 20 sets the virtual camera so as to include the player character object 102 within a field-of-view range in the virtual space, executes drawing processing based on the virtual camera, and generates the game image data corresponding to an image that is imaged with the virtual camera. That is, the game image data based on a result of the game control processing of the step S9 is generated. Although a detailed description is omitted, image data for inside information is also included in the game image data. Moreover, in a predetermined case, image data of the identification image is also included in the game image data.

Subsequently, the game image is displayed in a step S13. Here, the processor 20 outputs the game image data generated in the step S11 to the display device 30.

Furthermore, the parameter log is generated in a step S15, the generated parameter log is output to the information processing apparatus 14 in a step S17, the text log is generated in a step S19, the generated text log is output to the information processing apparatus 14 in a step S21, the time correspondence information log is generated in a step S23, and the generated time correspondence information log is output to the information processing apparatus 14 in a step S25. Therefore, the information processing apparatus 14 acquires, for each game frame, the parameter log, the text log and the time correspondence information log.

Then, in a step S27, it is determined whether the virtual game is to be ended. The determination in the step S27 is performed based on whether the player issues an instruction to end the virtual game. If “NO” is determined in the step S27, that is, if the virtual game is not to be ended, the process returns to the step S7. On the other hand, if “YES” is determined in the step S27, that is, if the virtual game is to be ended, the overall processing is terminated.

As shown in FIG. 13, if the game image generation processing is started, it is determined by the processor 20, in a step S31, whether it is during execution of the capture. If “YES” is determined in the step S31, that is, if it is during execution of the capture, it is determined, in a step 33, whether the error flag 304k is turned on. If “NO” is determined in the step S33, that is, if the error flag 304k is turned off, the process proceeds to a step S43. If “YES” is determined in the step S33, that is, if the error flag 304k is turned on, the process proceeds to a step S51 shown in FIG. 14.

If “NO” is determined in the step S31, that is, if it is not during execution of the capture, it is determined, in a step S35, whether it is the start of the capture. Here, the processor 20 determines whether there is any notice of having started the capture processing from the capture function. If “NO” is determined in the step S35, that is, if it is not the start of the capture, the process proceeds to the step S43.

On the other hand, if “YES” is determined in the step S35, that is, if it is the start of the capture, the count of the drawing time of the identification image (in the first embodiment, 1.1 seconds) is started in a step S37, the identification image drawing flag 304j is turned on in a step S39, and the game image data that includes the image data of the identification image is generated in a step S41, and then, the process returns to overall processing. In the first embodiment, the identification image is the green marker and the character string of the current game frame number. The current game frame number is a game frame number indicated by the game frame number data 304c.

Moreover, in the step S43, it is determined whether the identification image drawing flag 304j is turned on. If “NO” is determined in the step S43, that is, if the identification image drawing flag 304j is turned off, the process proceeds to a step S49. On the other hand, if “YES” is determined in the step S43, that is, if the identification image drawing flag 304j is turned on, it is determined, in a step S45, whether the drawing of the identification image is to be ended. Here, the processor 20 determines whether the count of the drawing time of the identification image is ended.

If “NO” is determined in the step S45, that is, if the drawing of the identification image is not to be ended, the process proceeds to the step S41. On the other hand, if “YES” is determined in the step S45, that is, if the drawing of the identification image is to be ended, the identification image drawing flag 304j is turned off in a step S47, and the game image data that does not include the image data of the identification image is generated in a step S49, and then, the process returns to the overall processing.

As shown in FIG. 14, in the step S51, it is determined whether the identification image drawing flag 304j is turned on. If “YES” is determined in the step S51, that is, if the identification image drawing flag 304j is turned on, the process proceeds to a step S59. On the other hand, if “NO” is determined in the step S51, that is, if the identification image drawing flag 304j is turned off, the count of the drawing time of the identification image is started in a step S53, the identification image drawing flag 304j is turned on in a step S55, and in a step S57, the game image data that includes the image data of the identification image is generated, and then, the process returns to the overall processing.

Moreover, in the step S59, it is determined whether the drawing of the identification image is to be ended. If “NO” is determined in the step S59, the process proceeds to the step S57. On the other hand, if “YES” is determined in the step S59, the identification image drawing flag 304j is turned off in a step S61, the error flag 304k is turned off in a step S63, and the game image data that does not include the image data of the identification image is generated in a step S65, and then, the process returns to the overall processing.

As shown in FIG. 15, when starting the analysis and specifying processing, the processor 40 decodes the video data in a step S101, expands the image data corresponding to the head video frame in the VRAM in a step S103, and searches the green marker in a predetermined area of the image data expanded into the VRAM (i.e., a range corresponding to the display area 120a) is a step S105.

In a subsequent step S107, it is determined whether the green marker is drawn in the display area 120a. If “NO” is determined in the step S107, that is, if the green marker is not drawn in the display area 120a, the process proceeds to a step S117. On the other hand, if “YES” is determined in the step S107, that is, if the green marker is drawn in the display area 120a, in a step S109, the character recognition processing (in the first embodiment, OCR processing) is executed in another predetermined are of the image data expanded into the VRAM (i.e., a range corresponding to the display area 120b).

In a next step S111, the recording time of the video frames corresponding to the image data expanded into the VRAM and its corresponding game frame number are specified, the time gap is calculated by subtracting the specified recording time from the game time corresponding to the specified game frame number in a step S113, and in a step S115, the time gap calculated in the step S113 is stored, and then, the analysis and specifying processing is terminated. That is, the processor 40 stores the time gap data 504g in the RAM 42. However, the specified game frame number is the game frame number recognized by the character recognition processing. The same is also applied to a step S129 described later.

In the step S117, it is determined whether the head 30 seconds of the video data has been scanned. If “NO” is determined in the step S117, that is, if the head 30 seconds of the video data has not been scanned, in a step S119, the image data corresponding to the video frame a predetermined number (in the first embodiment, five (5)) ahead is expanded into the VRAM, and the process returns to the step S105. On the other hand, if “YES” is determined in the step S117, that is, if the head 30 seconds of the video data has been scanned, the image data corresponding to the video frame 30 seconds before the tail of the video data is expanded into the VRAM. in a step S121 shown in FIG. 16

In a next step S123, the green marker is searched in the range corresponding to the display area 120a of the video data that is expanded into the VRAM. In a subsequent step S125, it is determined whether the green marker is drawn in the display area 120a. If “NO” is determined in the step S125, the process proceeds to a step S135. On the other hand, if “YES” is determined in the step S125, in a step S127, the character recognition processing is executed in the display area 120b of the image data expanded into the VRAM. Subsequently, in a step S129, the recording time of the video frames corresponding to the image data expanded into the VRAM and its corresponding game frame number are specified, the time gap is calculated in a step S131, and in a step S133, the time gap calculated in the step S131 is stored, and then, the analysis and specifying processing is terminated.

In the step S135, it is determined whether the tail 30 seconds of the video data has been scanned. If “NO” is determined in the step S135, that is, if the tail 30 seconds of the video data has not been scanned, in a step S137, the image data corresponding to the video frame a predetermined number (in the first embodiment, five (5)) ahead is expanded into the VRAM, and the process returns to the step S123. On the other hand, if “YES” is determined in the step S135, that is, if the tail 30 seconds of the video data has been scanned, the analysis and specifying processing is terminated.

As shown in FIG. 17, if the viewing processing is started, the processor 40 displays the viewing screen 200 on the display device 50 in a step S201. Here, the initial viewing screen 200 is displayed. In a next step S203, it is determined whether there is any playback instruction of the video. Here, the processor 40 determines whether the playback is instructed using the operation panel displayed on the display area 208.

If “YES” is determined in the step S203, that is, if the playback of the video is instructed, the process proceeds to a step S209. On the other hand, if “NO” is determined in the step S203, that is, if the playback of the video is not instructed, it is determined, in a step S205, whether the recording time, i.e., the playback position is designated.

If “NO” is determined in the step S205, that is, if the recording time is not designated, the process returns to the step S203. On the other hand, if “YES” is determined in the step S205, that is, if the recording time is designated, in a step S207, the recording time, i.e., the playback position is designated according to an instruction of the developer et al., and then, the process returns to the step S203.

In the step S209, the playback of the video is started. The processor 40 starts the playback of the video data 504f from the head when the playback position is not designated, and starts the playback of the video data 504f from the designated playback position when the playback position is designated. The video that the video data 504f is played-back is displayed in the display area 202 of the viewing screen 200.

In a next step S211, the game time according to the current time is specified using the time gap data 504g. A method of specifying (calculating) the game time according to the current time is as described above. In a subsequent step S213, the parameter log of the game frame number corresponding to the specified game time is output, and in a step S215, the text log of the game frame number corresponding to the specified game time is output. Therefore, the parameter log of the game time corresponding to the recording time of the video frame of the video data 504f currently being played-back is displayed in the display area 206 of the viewing screen 200, and the text log of the game time is displayed in the display area 204 of the viewing screen 200. That is, the viewing image that the log and the video synchronized with each other is displayed. In addition, the processor 40 specifies the game frame number corresponding to the game time with reference to the time correspondence information log data 504e.

Then, in a step S217, it is determined whether the viewing is to be ended. Here, the processor 40 determines whether the end of the viewing is instructed. If “NO” is determined in the step S217, that is, if the viewing is not to be ended, other processing is executed in a step S219, and the process returns to the step S211. As other processing, processor 40 changes the playback position, pauses, fast-forward plays-back or rewind plays-back according to an instruction by the developer et al. On the other hand, if “YES” is determined in the step S217, that is, if the viewing is to be ended, the viewing processing is terminated.

According to the first embodiment, in a predetermined case, the game image including the identification image that indicates the game frame number is displayed as a timing of displaying the game image, and therefore, it is possible to include the image data of the identification image in the video data that the game image is captured. Therefore, by detecting the identification image included in the video, it is possible to specify the recording time of the video frame and the game frame number corresponding to this recording time, and to perform the viewing while making the log and the video be synchronized with each other based on the recording time and the game frame number that are specified. That is, since it is possible to specify when the video is captured, and the video can be viewed while being synchronized with the log, and therefore, it is possible to reduce the time and effort required to confirm the operation of the under-development game program.

In addition, although the green marker and the character string of the game frame number are displayed as the identification image in the first embodiment, it is a reason for reducing the load of the processor by the OCR processing when scanning the video. When not taking the load of the processor into consideration, the green marker may be omitted and thus only the character string of the game frame number is displayed. In such a case, the steps S105, S107, S125 and S127 shown in FIG. 15 are deleted, and processing that determines whether the game frame number is detected is added between the steps S109 and S111 and between the steps S129 and S131, respectively. Moreover, when the game frame number is detected in the processing between steps S109 and S111, the process proceeds to the step S111, and when not detecting the game frame number, the process proceeds to the step S117. When the game frame number is detected in the processing between steps S129 and S131, the process proceeds to the step S131, and when not detecting the game frame number, the process proceeds to the step S135.

Moreover, in the first embodiment, when the capture is started, and when an error occurs during the execution of the game program, the identification image is displayed, but should not be limited. When the player character object is moved to a predetermined place or when the player instructs the display (or drawing) of the identification image, the identification image may be displayed. In such a case, in the information processing apparatus, video data after moving to the predetermined place until leaving the place is generated. Moreover, when the display of the identification image is instructed, similar to a case where an error occurs, video data that a position that the display of the identification image is ended is the tail and a position that the second predetermined time back from the tail is the head is generated.

Furthermore, in the first embodiment, although the game image is captured by the game apparatus, the game image data may be recorded at a side of the information processing apparatus by transmitting the game image data corresponding to the game image to the information processing apparatus. In such a case, the information processing apparatus may be provided with a function for recording the game image data, and may be connected with a capture device. In this case, the information processing apparatus acquires the video data through the function provided on its own apparatus, or acquires the video data from the capture device connected to its own apparatus. Moreover, when recording is started at a side of the information processing apparatus, it is notified to the game apparatus that the recording is started by the information processing apparatus.

Moreover, the video data that the game screen displayed on the display device is imaged by a video camera may be transmitted to the information processing apparatus. That is, the information processing apparatus acquires the video data from the video camera. However, when a file format of the video data imaged with the video camera is not MP4, a file format is changed into MP4. When imaging with the video camera, it is notified to the game apparatus by an operation of the player that the recording is started. Moreover, when the game screen is imaged by the video camera, a position of an origin of the game screen may be deviated from a position of an origin of the video frame. When the origin positions are deviated from each other, a range that the identification image is to be searched is changed according to deviation.

Furthermore, in the first embodiment, in the predetermined case, as the timing that the game image is to be displayed, this game image is displayed with including the identification image that indicates the game frame number; however, the game image may be displayed with including the identification image that indicates the game time. In such a case, in the analysis and specifying processing, the game time corresponding to the recording time is specified, and then, the time gap is calculated. Even by such a method, it is possible to view the log and the video synchronously with each other.

In addition, in the first embodiment, the game time corresponding to the playback time of the video is specified and the parameter log and text log of the game frame number corresponding to the game time are displayed in consideration of a case of a variable frame rate; however, in a case of a fix frame rate, it is possible to display the parameter log and the text log of the game frame number corresponding to the playback time of the video in another method. As described later, the information processing apparatus 14 does not use the time correspondence information log in this case, the game apparatus 12 does not generate and output the time correspondence information log.

Specifically, using a time (hereinafter, referred to as “difference time”) that the recording time of the video frame that the game frame number is specified (hereinafter, referred to as “specified time”) is subtracted from the current time of the video data during playback, a frame rate of the game image in the game apparatus 12 and a frame rate of the video, the video frame number corresponding to the difference time is calculated.

When the frame rate of the game image in the game apparatus 12 (hereinafter, referred to as “first frame rate”) and the frame rate of the video data (hereinafter, referred to as “second frame rate”) are the same, the game frame number that the video frame number corresponding to the difference time is added to the specified game frame number is the game frame number corresponding to the current time. In addition, the first frame rate and the second frame rate are acquired, after acquiring the video and the logs, from information included therein, and set to the information processing apparatus 14.

Moreover, when the first frame rate and the second frame rate are different from each other, the video frame number corresponding to the difference time is changed according to the difference of the frame rate. Specifically, the number that the first frame rate is divided by the second frame rate is multiplied by the video frame number corresponding to the difference time. Then, the game frame number that a value that the video frame number corresponding to the difference time is changed is added to the specified game frame number is the game frame number corresponding to the current time. However, when the current time is preceding than the specified time, the video frame number corresponding to the difference time is a negative value.

In either one of a case where the first frame rate and the second frame rate are the same and a case where the first frame rate and the second frame rate are different from each other, the parameter log and the text log for the game frame number corresponding to the calculated current time are displayed on the viewing screen 200.

### Second Embodiment

A game development support system 10 according to the second embodiment is the same or similar to the first embodiment except that an identification image that is displayed on the game apparatus 12 and searched by the information processing apparatus 14 is different from that of the first embodiment, and therefore, a different configuration will be described and a duplicate description will be omitted.

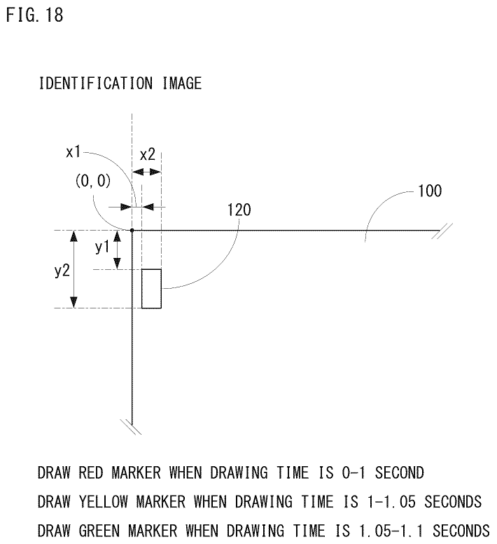

FIG. 18 is an enlarged view showing an upper left portion of the game screen 100 of the second embodiment. As shown in FIG. 18, in the second embodiment, the display area 120 is set as the same or similar to the display area 120a of the first embodiment. In FIG. 18, the display area 120 is indicated with a square frame in order to show the display area 120 intelligibly, but in an actual game screen 100, it is not necessary to display such a square frame.

Moreover, in the second embodiment, markers of different colors are displayed sequentially as an identification image in the drawing time, i.e., the first predetermined time (specifically 1.1 seconds). That is, a pattern of predetermined colors is displayed. Specifically, during the one (1) second of the drawing time, a red marker is displayed in the display area 120 as an identification image. In the next 0.05 seconds, a yellow marker is displayed in the display area 120 as an identification image. In the further next 0.05 seconds, a green marker is displayed in the display area 120 as an identification image.

In addition, in the second embodiment, when a timing that the drawing time is one (1) second, the red marker is displayed on the display area 120, but the yellow marker may be displayed. Moreover, in the second embodiment, when a timing that the drawing time is 1.05 seconds, the yellow marker is displayed on the display area 120, but the green marker may be displayed.

However, the display area 120 of the second embodiment may be provided in a separate position from the display area 120a of the first embodiment. In such a case, a range that a color, i.e., the identification image is to be searched in the information processing apparatus 14 is set to the display area 120 provided in the separate position.

Moreover, in the second embodiment, when the drawing of each color marker is started, the color of the marker and the game frame number at the time that the drawing of this color marker is started (hereinafter, referred to as “frame number correspondence information”) are notified to the information processing apparatus 14. For example, when the game frame number that the drawing of the red marker is started is “7343”, information that indicates a red color and the information that indicates “7343” is notified as the frame number correspondence information to the information processing apparatus 14.

Since the red marker is displayed for one (1) second, when the game frame is 1/60 seconds, the game frame number at the time that the drawing of the yellow marker is started is “7403”. Therefore, when the drawing of the yellow marker is started, the information that indicates a yellow color and “7403” is notified to the information processing apparatus 14 as the frame number correspondence information.

Since the yellow marker is displayed for 0.05 seconds, when the game frame is 1/60 seconds, and the game frame number is “7406” at the time that the drawing of the green marker is started. Therefore, when starting the drawing of the green marker, the information that indicates a green color and “7406” is notified to the information processing apparatus 14 as the frame number correspondence information.

Thus, in the second embodiment, the identification image displayed is different from the first embodiment, and therefore, in a part of the analysis and specifying processing executed by the information processing apparatus 14 is different from the analysis and specifying processing in the first embodiment. Here, the analysis and specifying processing of the second embodiment will be described.

In the analysis and specifying processing, first, the video data is decoded according to the file format of MP4. The image data corresponding to the head video frame of the decoded video data is expanded into the VRAM, and it is determined whether the red marker, the yellow marker or the green marker is displayed within the range corresponding to the display area 120 out of the image data expanded into the VRAM. That is, it is determined whether a color value (i.e., value of RGB) of the pixel within the range corresponding to the display area 120 indicates a red color, a yellow color or a green color.

If the red marker, the yellow marker or the green marker is detected in the range corresponding to the display area 120, with reference to the frame number correspondence information notified from the game apparatus 12, the game frame number of the color of the detected marker is specified corresponding to the recording time of the video frame corresponding to the image data that the marker of this color is detected.

As described above, the red marker is displayed for one (1) second and the yellow marker and green marker are displayed for 0.05 seconds, respectively. Therefore, in the video frame that the red marker is detected, there is a possibility that the game frame number is deviated one (1) second (in the second embodiment, 60 game frames) at maximum. In contrast, in the video frames that the yellow marker or the green marker is detected, there is a possibility that the game frame number is deviated by up to 0.05 seconds (three (3) game frames).

Therefore, in the second embodiment, in order to minimize the gap between the recording time of the video frame and the game frame number as possible, when the green marker is detected in the range corresponding to the display area 120, the recording time of the video frame corresponding to the image data that the green marker is detected and the game frame number corresponding to this recording time are specified even if the yellow maker and the red marker are also detected. This game frame number is the game frame number corresponding to the green color in the frame number correspondence information notified from the game apparatus 12.

However, when the yellow marker and the green marker are detected, the recording time of the video frame corresponding to the image data that the yellow marker is detected and the game frame number corresponding to this recording time may be specified. This game frame number is the game frame number corresponding to the yellow color in the frame number correspondence information notified from the game apparatus 12.

When the green marker is not detected in the range corresponding to the display area 120, if the yellow marker is detected, even if the red marker is also detected, the recording time of the video frame corresponding to the image data that the yellow marker is detected and the game frame number corresponding to this recording time are specified. This game frame number is the game frame number corresponding to the yellow color in the frame number correspondence information notified from the game apparatus 12.

When only the red marker is detected in the range corresponding to the display area 120, the recording time of the video frame the red marker is first detected and the game frame number corresponding to this recording time are specified. This game frame number is the game frame number corresponding to the red color in the frame number correspondence information notified from the game apparatus 12.

In addition, a reason why the game frame number is specified corresponding to the recording time of the video frame the red marker is first detected is that the red marker is displayed for one (1) second in the game image and thus may be detected two or more times.

In also the second embodiment, since the identification image is drawn in the display area 120 of the predetermined position of the game image, it is sufficient to detect only a color of the marker drawn in the range corresponding to the display area 120 in the image analysis processing, and therefore, the identification image can be specified or detected with simple structure. Therefore, it is possible to easily specify the recording time of the video frame corresponding to the image data including the identification image and its corresponding game frame number.

On the other hand, if the red marker, the yellow marker and the green marker are not detected in the range corresponding to the display area 120, it is determined whether the red marker, the yellow marker or the green marker is detected in the video frame the predetermined number (e.g., five (5)) ahead.

When the video data for 30 seconds from the head is scanned, and the red marker, the yellow marker or the green marker is not detected, the tail 30 seconds of the video data is scanned. The scan of the tail 30 seconds of the video data is the same as the scan of 30 seconds including the head video frame.

Therefore, in the second embodiment, the identification image drawing program 302i stored in the program store area 302 of the RAM 22 of the game apparatus 12 displays a pattern of the predetermined colors on the game apparatus 12 in response to the start of recording and the occurrence of an error.

Moreover, in the second embodiment, the program storage area 302 of the RAM 22 of the game apparatus 12 is further stored with a program for notifying, at a timing that drawing (or display) of each color is to be started, to the information processing apparatus 14 a color to be displayed and the game frame number that this color is started to be drawn, i.e., the frame number correspondence information. When this program is to be executed, the communication program 302b is also executed.

Moreover, in the second embodiment, the image analysis program 502h stored in the program storage area 502 of the RAM 42 of the information processing apparatus 14 detects the red marker, the yellow marker or the green marker that is displayed in the range corresponding to the display area 120 in the image data corresponding to the video frame. Moreover, when detecting the green marker, the specifying program 502i specifies the recording time of the video frame and the game frame number corresponding to the green marker in the frame number correspondence information notified from the game apparatus 12 corresponding to this recording time. When detecting the yellow marker and not detecting the green marker, the specifying program 502i specifies the recording time of the video frame and the game frame number corresponding to the yellow marker in the frame number correspondence information notified from the game apparatus 12 corresponding to this recording time. When detecting only the red marker, the specifying program 502i specifies the recording time of the video frame that the red marker is first detected and the game frame number corresponding to the red marker in the frame number correspondence information notified from the game apparatus 12 corresponding to this recording time.

In addition, if the gap between the recording time of the video frame and the game time corresponding to the frame number is equal to or less than 0.05 seconds, it is possible to consider that the log and the video are synchronized with each other. Moreover, even if detecting only the red marker, actually, the recording time and the game time rarely deviate from each other by one (1) second, so even in such a case, it is possible to consider that the log and the video are synchronized with each other.

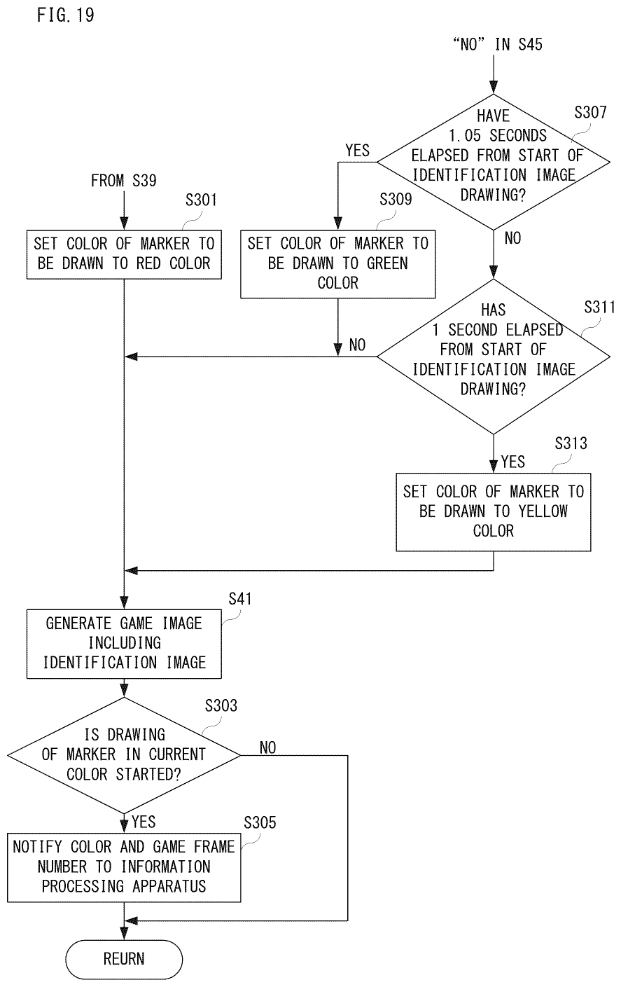

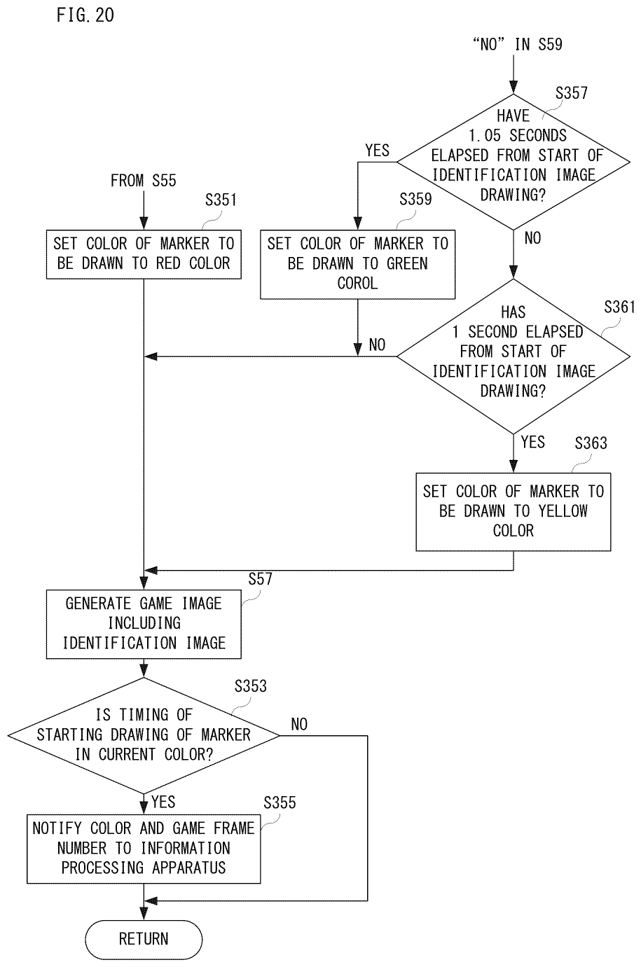

FIG. 19 and FIG. 20 are flowcharts showing a part of non-limiting example game image generation processing in the second embodiment. The game image generation processing shown in FIG. 19 and FIG. 20 is the processing that the game image generation processing shown in FIG. 13 and FIG. 14 is changed in part. Although game image generation processing of the second embodiment will be described with reference to FIG. 19 and FIG. 20, as to the same processing as the game image generation processing of the first embodiment, an illustration and a description will be omitted.

As shown in FIG. 19, a step S301 is provided between the step S39 and the step S41, a step S303 and a step S305 are provided after the step S41, and steps S307, S309, S311 and S313 are provided between the step S41 and “NO” in the step S45.

Specifically, after execution of the processing of the step S39, in the step S301, a color of the marker to be drawn (or displayed) is set to a red color, and, the process proceeds to the step S41. In the step S41, the game image that includes the marker of the set color in the display area 120 is generated. After execution of the processing of the step S41, it is determined, in the step S303, whether it is a timing that the drawing of the marker of the current color is started.

If “YES” is determined in the step S303, that is, if it is a timing that the drawing of the marker of the current color is started, in the step S305, information of the color and the game frame number, i.e., the frame number correspondence information is notified to the information processing apparatus 14, and the process returns to the overall processing. However, the game frame number notified in the step S305 is the current game frame number.

On the other hand, if “NO” is determined in the step S303, that is, if it is not a timing that the drawing of the marker of the current color is started, the process returns to the overall processing.

Moreover, if “NO” is determined in the step S45, it is determined, in the step S307, whether 1.05 seconds elapsed from the drawing start of the identification image. If “YES” is determined in the step S307, that is, if 1.05 seconds elapsed from the drawing start of the identification image, a color of the marker to be drawn is set to a green color in the step S309, and the process proceeds to the step S41.

On the other hand, if “NO” is determined in the step S307, that is, if 1.05 seconds did not elapse from the drawing start of the identification image, it is determined, in the step S311, whether one (1) second elapsed from the drawing start of the identification image.

If “NO” is determined in the step S311, that is, if one (1) second does not elapse from the drawing start of the identification image, the process proceeds to the step S41. On the other hand, if “YES” is determined in the step S311, that is, if one (1) second elapsed from the drawing start of the identification image, a color of the marker to be drawn is set to a yellow color in the step S313, and the process proceeds to the step S41.

Moreover, as shown in FIG. 20, a step S351 is provided between the step S55 and the step S57, a step S353 and a S355 are provided after the step S57, and steps S357, S359, S361 and S363 are provided between the step S59 and “NO” in the step S57. In the following, these processing will be described, but these processing are the same as the processing described with reference to FIG. 19, and therefore, described briefly.

As shown in FIG. 20, after execution of the processing of the step S55, in the step S351, a color of the marker to be drawn is set to a red color, and, the process proceeds to the step S41. After execution of the processing of the step S41, it is determined, in the step S353, whether it is a timing that the drawing of the marker of the current color is started.

If “YES” is determined in the step S353, in the step S355, information of the color and the game frame number is notified to the information processing apparatus 14, and the process returns to the overall processing. On the other hand, if “NO” is determined in the step S353, the process returns to the overall processing.

Moreover, if “NO” is determined in the step S59, it is determined, in the step S357, whether 1.05 seconds elapsed from the drawing start of the identification image. If “YES” is determined in the step S357, a color of the marker to be drawn is set to a green color in the step S359, and the process proceeds to the step S57. On the other hand, if “NO” is determined in the step S357, it is determined, in the step S361, whether one (1) second elapsed from the drawing start of the identification image.

If “NO” is determined in the step S361, the process proceeds to the step S57. On the other hand, if “YES” is determined in the step S361, a color of the marker to be drawn is set to a yellow color in the step S363, and the process proceeds to the step S57.

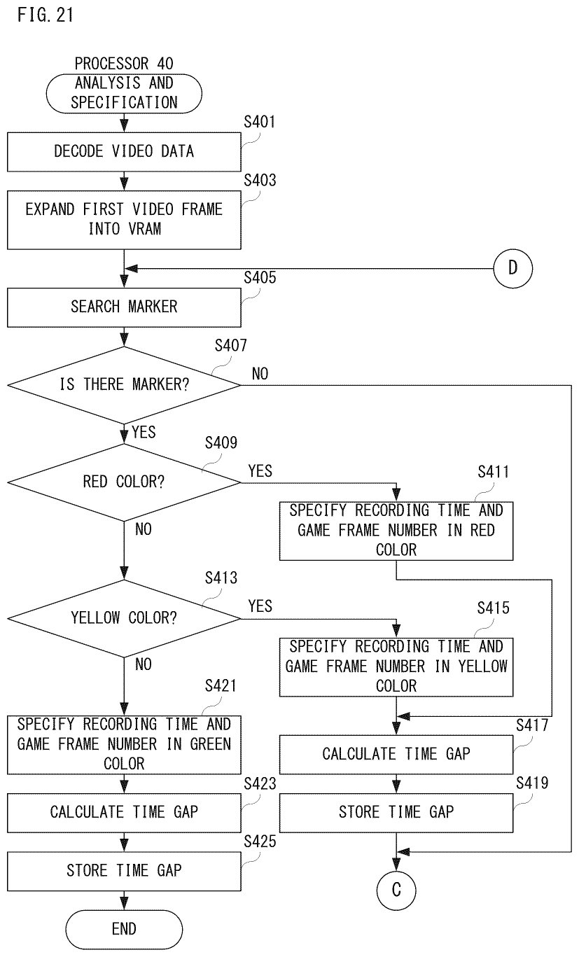

FIG. 21-FIG. 23 are flowcharts showing non-limiting example analysis and specifying processing of the processor 40 of the information processing apparatus 14 according to the second embodiment. Although the analysis and specifying processing of the second embodiment will be described in the following, as to the same processing of the analysis and specifying processing of the first embodiment, described briefly.

As shown in FIG. 21, when starting the analysis and specifying processing, the processor 40 decodes the video data in a step S401, expands the image data corresponding to the head video frame into the VRAM in a step S403, and searches the red marker, the yellow marker or the green marker in the predetermined area (i.e., range corresponding to the display area 120) of the image data expanded into the VRAM in a step S405.

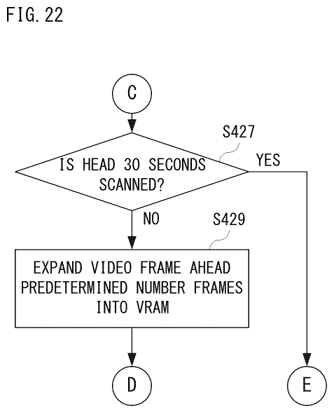

In a subsequent step S407, it is determined whether the red marker, the yellow marker or the green marker is drawn in the display area 120. If “NO” is determined in the step S407, that is, if the red marker, the yellow marker or the green marker is not drawn in the display area 120, the process proceeds to a step S427 shown in FIG. 22. On the other hand, if “YES” is determined in the step S407, that is, if the red marker, the yellow marker or the green marker is drawn in the display area 120, it is determined, in a step 409, whether the color of the marker is a red color.

If “YES” is determined in the step S409, that is, if the color of the marker is a red color, in a step S411, the recording time is specified and the game frame number corresponding to the red color with reference to the frame number correspondence information is specified, and then, the process proceeds to a step S417. The recording time is a recording time of the video frame corresponding to the image data expanded into the VRAM. This is the same for steps S415, S421, S439, S443 and S447 described later.

On the other hand, if “NO” is determined in the step S409, that is, if the color of the marker is not a red color, it is determined, in a step S413, whether a color of the marker is a yellow color. If “YES” is determined in the step S413, that is, if the color of the marker is a yellow color, in a step S415, the recording time is specified and the game frame number corresponding to the yellow color with reference to the frame number correspondence information is specified, and then, the process proceeds to the step S417.

In the step S417, the time gap is calculated, and in a step S419, the time gap is stored, and then, the process proceeds to a step S427. That is, in the step S419, the processor 40 stores the time gap data 504g. Although the time gap data 504g is basically updated in the step S419, when processing of the step S411 has been already (or once) executed, the processing of the steps S411, S417 and S419 are skipped. This is for specifying the game frame number corresponding to the recording time of the video frame corresponding to the image data that the red marker is first detected. These are the same also for a step S439 and steps S451 and S453 described later.

If “NO” is determined in the step S413, that is, if the color of the marker is a green color, in a step S421, the recording time is specified and the game frame number corresponding to the green color with reference to the frame number correspondence information is specified, and the time gap is calculated in a step S423, and then, the analysis and specifying processing is terminated. In the step S425, the time gap data 504g is updated. This is the same for a step S447 described later.

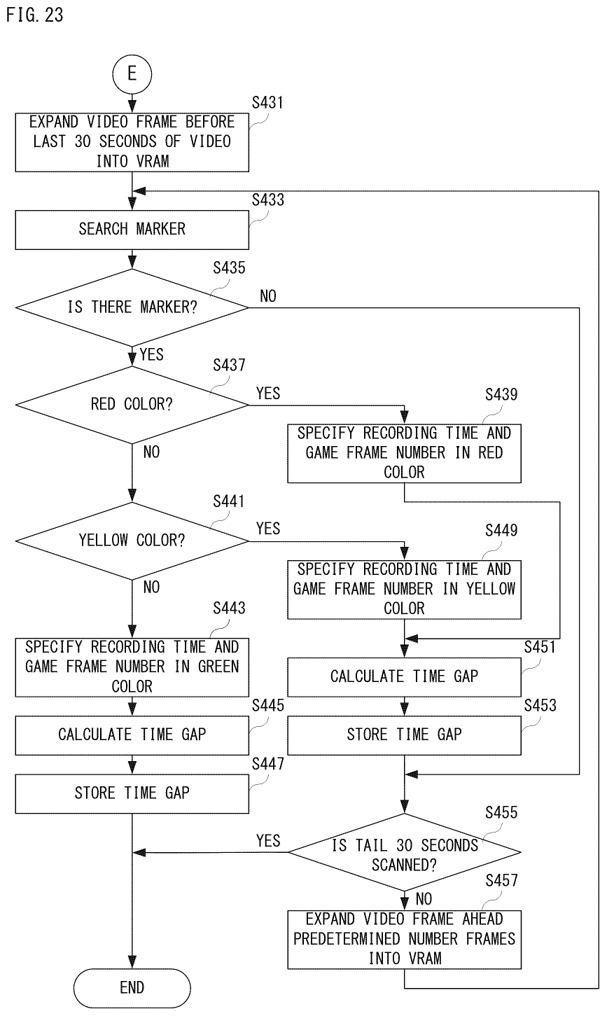

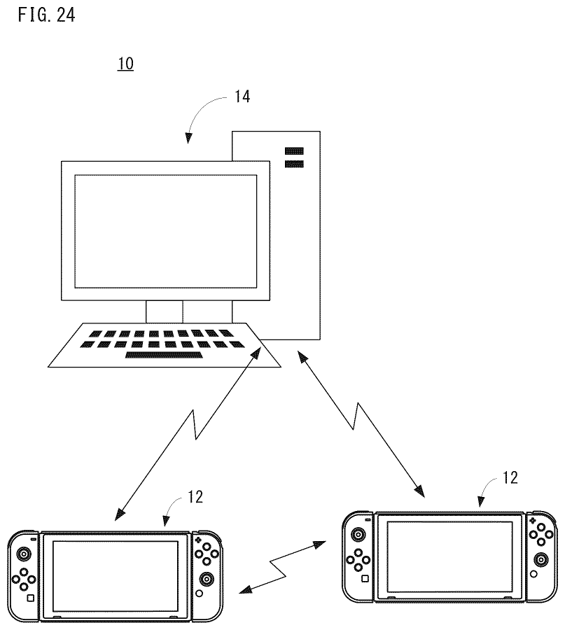

As shown in FIG. 22, it is determined, in the step S427, whether the head 30 seconds of the video data is scanned. If “NO” is determined in the step S427, in a step S429, the video frame a predetermined number (in the second embodiment, five (5)) ahead is expanded into the VRAM, and the process returns to the step S405. On the other hand, if “YES” is determined in the step S427, in a step S431 shown in FIG. 23, the video frame 30 seconds before the tail of the video data is expanded into the VRAM.

In a next step S433, the red marker, the yellow marker or the green marker is searched in a range corresponding to the display area 120 of the video data that is expanded into the VRAM. In a subsequent step S435, it is determined whether the red marker, the yellow marker or the green marker exists in the range corresponding to the display area 120. If “NO” is determined in the step S435, the process proceeds to a step S455. On the other hand, if “YES” is determined in the step S435, it is determined, in a step S437, whether the color of the marker is a red color.

If “YES” is determined in the step S437, in a step S439, the recording time is specified and the game frame number corresponding to the red color with reference to the frame number correspondence information is specified, and the process proceeds to a step S451. On the other hand, if “NO” is determined in the step S437, it is determined, in a step S441, whether the color of the marker is a yellow color.

If “NO” is determined in the step S441, in a step S443, the recording time is specified and the game frame number corresponding to the green color with reference to the frame number correspondence information is specified. Subsequently, in a step S445, the time gap is calculated, and in a step S447, the time gap is stored, and then, the analysis and specifying processing is terminated. On the other hand, if “YES” is determined in the step S441, in a step S449, the recording time is specified and the game frame number corresponding to the yellow color with reference to the frame number correspondence information is specified, and the process proceeds to the step S451. In the step S451, the time gap is calculated, and in a step S453, the time gap is stored, and then, the process proceeds to a step S455.

In the step S455, it is determined whether the tail 30 seconds of the video data is scanned. If “NO” is determined in the step S455, the video frame a predetermined number ahead is expanded into the VRAM in a step S457, and the process returns to the step S433. On the other hand, if “YES” is determined in the step S455, the analysis and specifying processing is terminated.

In also the second embodiment, similar to the first embodiment, the video can be viewed while being synchronized with the log, and therefore, it is possible to reduce the time and effort required to confirm the operation of the under-development game program.

In addition, in the second embodiment, a time period that each of the yellow marker and the green marker is drawn is shorter than a time period that the red marker is drawn, if the red marker is detected when scanning the video data, an interval between the video frames to be scanned may be shortened. In this method, a probability of detecting the yellow marker or the green marker is increased, and thus, it is possible to synchronize the log and the video more precisely.

Moreover, in the second embodiment, when starting the drawing the marker of each color, the color of the marker and the game frame number at the time that the drawing of the marker of the color is started are notified to the information processing apparatus 14; however, the color of the marker and the game time when the drawing of the marker is started may be notified to the information processing apparatus 14. In such a case, in the analysis and specifying processing, the game time corresponding to the recording time is specified, and the time gap is calculated. Even by such a method, it is possible to view the log and the video synchronously with each other.

Furthermore, although a detailed description is omitted, a modification in the first embodiment is employable suitably also in the second embodiment.

### Third Embodiment

A game development support system 10 according to the third embodiment is the same as the first embodiment and the second embodiment except that when executing a game program of a communication game by a plurality of game apparatuses 12, for each of the game apparatuses 12, a log and a video are displayed synchronously with each other. Here, only different contents will be described while omitting description as to contents the same or similar to the first embodiment and the second embodiment.

A game development support system 10 shown in FIG. 24 includes two game apparatuses 12 and the information processing apparatus 14. In the third embodiment, the two game apparatuses 12 communicate mutually and a game program of a communication game is executed in each of the game apparatuses 12. Moreover, the two game apparatuses 12 communicate with the information processing apparatus 14, respectively to transmit a log and a video to the information processing apparatus 14.

A method of displaying the log and the video for each game apparatus 12 in the information processing apparatus 14 is as described in the first embodiment and the second embodiment. Although illustration is omitted, in the third embodiment, the viewing screen 200 shown in FIG. 5 is displayed as to respective game apparatuses 12 as a glance. However, it is not necessary to provide the display area 208, i.e., an operation panel in each viewing screen 200.

The third embodiment is further made to synchronize the log and the video between the respective game apparatuses 12. As an example, by making the time counted with the respective game apparatuses 12 correspond to each other, and by notifying the information processing apparatus 14 the information of the time (i.e., hours, minutes and seconds) counted by each of the game apparatuses 12 (for convenience of description, referred to as “first time information”) by adding the first time information to the log when transmitting the log from each of the game apparatuses 12, the information processing apparatus 14 can synchronize the log and the video between the respective game apparatuses 12 using the first time information. However, the first time information may be added to the video.

Alternatively, when the information processing apparatus 14 receives the log that is transmitted from each game apparatus 12, by adding the information of the time counted with the information processing apparatus 14 (for convenience of description, referred to as “second time information”) to the log for each game apparatus 12, the information processing apparatus 14 can synchronize the log and the video between the respective game apparatuses 12 using the second time information. However, the second time information may be added to the video.

These are the same for a case where there are three or more game apparatuses 12 that conduct the communication game.

According to the third embodiment, it is possible to synchronously display the log and the video on each of the plurality of game apparatuses each conducting the game program of the communication game, and to display the log and the video synchronously out of the plurality of game apparatuses. Similar to the first embodiment and the second embodiment, it is possible to reduce the time and effort required to confirm the operation of the under-development game program.

In addition, the structure, various kinds of screens, specific numeral values, etc. shown in the above-described respective embodiments are mere examples, should not be limited and can be appropriately changed according to actual products.

Moreover, if the same or similar result is obtainable, an order of the respective steps shown in the flowcharts may be exchanged.

Although certain example systems, methods, storage media, devices and apparatuses have been described herein, it is to be understood that the appended claims are not to be limited to the systems, methods, storage media, devices and apparatuses disclosed, but on the contrary, are intended to cover various modifications and equivalent arrangements included within the spirit and scope of the appended claims.

What is claimed is:

1. A game development support system comprising at least a game apparatus capable of executing an under-development game program and an information processing apparatus, wherein the under-development game program causes a computer of the game apparatus to execute:
outputting a log during execution of game processing, the log including timing information; and
generating, within at least a predetermined period during execution of the game processing, a game image so that an identification image by which a timing that the game image is output is identifiable is included therein; wherein
the information processing apparatus is caused to execute:
acquiring the log from the game apparatus;
acquiring video data that is generated by capturing the game image;
performing image analysis to the video data so as to specify a frame in which the identification image is included in the video, and to specify a timing that the game image in which the identification image is included is output; and
generating, based on specified timing and the timing information included in the log, a viewing image that includes at least the log and the video that are displayed synchronously.

2. The game development support system according to the claim 1, wherein the identification image includes an image of information indicating a timing that the game image is being output, the image being located at a predetermined position in the game image.

3. The game development support system according to the claim 2, wherein the identification image includes an image of character information that indicates a number of frames at a game start or from a predetermined timing after the game start.

4. The game development support system according to the claim 1, wherein the identification image includes an image of information that is located at a predetermined position of the game image at a predetermined timing after a game start, wherein
the under-development game program causes the computer of the game apparatus to further execute outputting information that indicates a first timing that the image of information is located at the predetermined position of the game image.

5. The game development support system according to the claim 4, wherein the identification image includes a pattern image of a predetermined color.

6. The game development support system according to the claim 1, wherein the game apparatus generates the video data by capturing the game image, and the information processing apparatus receives the video data from the game apparatus.

7. The game development support system according to the claim 1, wherein the information processing apparatus generates the video data by capturing the game image.

8. The game development support system according to the claim 1, wherein the information processing apparatus acquires video data that the game image displayed a display device is imaged by an imaging device.

9. The game development support system according to the claim 1, wherein the under-development game program causes the computer of the game apparatus to further execute:
detecting that a predetermined error occurs during execution of the game processing;
generating the game image that includes the identification image when the predetermined error is detected; and
transmitting video data of a predetermined time period that includes at least a timing that the game image including the identification image is generated in response to occurrence of the predetermined error to the information processing apparatus.

10. A game development support method of a game development support system that comprises at least a game apparatus capable of executing an under-development game program and an information processing apparatus capable of an information processing program, wherein the under-development game program causes a computer of the game apparatus to execute:
outputting a log during execution of game processing, the log including timing information; and
generating, within at least a predetermined period during execution of the game processing, a game image so that an identification image by which a timing that the game image is output is identifiable is included therein; wherein
the information processing program causes a computer of the information processing apparatus to execute:
acquiring the log from the game apparatus;
acquiring video data that is generated by capturing the game image;
performing image analysis to the video data so as to specify a frame in which the identification image is included in the video, and to specify a timing that the game image in which the identification image is included is output; and
generating, based on specified timing and the timing information included in the log, a viewing image that includes at least the log and the video that are displayed synchronously.

11. The game development support method according to the claim 10, wherein the identification image includes an image of information indicating a timing that the game image is being output, the image being located at a predetermined position in the game image.

12. The game development support method according to the claim 11, wherein the identification image includes an image of character information that indicates a number of frames at a game start or from a predetermined timing after the game start.

13. The game development support method according to the claim 10, wherein the identification image includes an image of information that is located at a predetermined position of the game image at a predetermined timing after a game start, and the log includes information indicating a timing that the information is included in the game image.

14. The game development support method according to the claim 13, wherein the identification image includes a pattern image of predetermined colors.

15. The game development support method according to the claim 10, wherein
the under-development game program causes the computer of the game apparatus to execute generating the video data by capturing the game image, and
the information processing program causes the computer of the information processing apparatus to execute receiving the video data from the game apparatus.

16. The game development support method according to the claim 10, wherein the information processing program causes the computer of the information processing apparatus to execute generating the video data by capturing the game image.

17. The game development support method according to the claim 10, wherein the information processing program causes the computer of the information processing apparatus to execute acquiring video data by imaging the game image by an imaging device.

18. The game development support method according to the claim 10, wherein the under-development game program causes the computer of the game apparatus to further execute:
detecting that a predetermined error occurs during execution of the game processing;
generating the game image that includes the identification image when the predetermined error is detected; and
transmitting video data of a predetermined time period that includes at least a timing that the game image including the identification image is generated in response to occurrence of the predetermined error.

19. An information processing apparatus including one or more processors caused to execute:
acquiring the log from the game apparatus game capable of executing an under-development game program;
acquiring video data that is generated by capturing a game image that an identification image by which a timing that the game image is output is identifiable is included therein;
performing image analysis to the video data so as to specify a frame in which the identification image is included in the video, and to specify a timing that the game image in which the identification image is included is output; and
generating, based on specified timing and timing information included in the log, a viewing image that includes at least the log and the video that are displayed synchronously.

20. A non-transitory computer-readable storage medium having stored with an information processing program executable by an information processing apparatus comprising one or more processors, wherein the information processing program causes the one or more processors of the information processing apparatus to execute:
acquiring the log from the game apparatus game capable of executing an under-development game program;
acquiring video data that is generated by capturing a game image that an identification image by which a timing that the game image is output is identifiable is included therein;
performing image analysis to the video data so as to specify a frame in which the identification image is included in the video, and to specify a timing that the game image in which the identification image is included is output; and
generating, based on specified timing and timing information included in the log, a viewing image that includes at least the log and the video that are displayed synchronously.
